(19) United States
(12) Patent Application Publication
(10) Pub. No.: US 2008/0258613 A1
(43) Pub. Date: Oct. 23, 2008

(54) ORGANIC ELECTROLUMINESCENCE DEVICE

(75) Inventors: Kenichi FUKUOKA, Sodegaura-shi (JP); Hisayuki Kawamura, Sodegaura-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Idemitsu Kosan Co., Ltd., Chiyoda-ku (JP)

(21) Appl. No.: 12/103,931

(22) Filed: Apr. 16, 2008

(30) Foreign Application Priority Data
Apr. 20, 2007 (JP) 2007-112154

(51) Int. Cl. H01J 1/63; B32B 9/04; C09K 11/00

(52) U.S. Cl. 313/504; 428/690

(57) ABSTRACT

An electroluminescence device including an anode, a cathode, and an emitting layer interposed between the anode and the cathode, in which the emitting layer contains a host, a first dopant, and a second dopant, a luminous intensity of the first dopant is twelve times as great as a luminous intensity of the second dopant or greater, a content of the second dopant is 0.001% by mass to 0.5% by mass, and the emitting layer is formed by a coating process.

### BACKGROUND OF THE INVENTION

1. Field of the Invention

The present invention relates to an organic electroluminescence device, and in particular, to an organic electroluminescence device that has a long light-emitting lifetime.

2. Description of Related Art

Conventionally, an organic electroluminescence device (hereafter abbreviated to OELD) described below is known.

An OELD includes an anode, a cathode, and an emitting layer made of organic compounds interposed between the anode and the cathode.

When voltage is applied to the OELD, a current flows through the emitting layer.

Released energy from recombination of an electron and a hole in the emitting layer is then taken out as light.

Here, a configuration in which the emitting layer is not constituted by a single organic compound, but a dopant material is added to a host material is known (e.g., Document 1: JP-A-07-288184).

A dopant is normally doped to a host approximately in 0.1 to 20% by mass.

Such a configuration can provide an OELD with an excellent luminous efficiency and an extended lifetime.

For further improvements, especially for extending a lifetime, a dopant is known to be doped to the subsidiary layer adjacent to the emitting layer instead of the emitting layer (e.g., Document 2: JP-A-2003-051388, Document 3: U.S. Pat. No. 5,989,737, and Document 4: JP-A-2004-221045).

According to Document 2, a subsidiary layer (secondary layer) adjacent to an emitting layer is provided to a hole transporting layer or an electron transporting layer adjacent to the emitting layer, and a color-neutral dopant that does not contribute to luminescence is doped to the secondary layer.

According to Document 3, a polycyclic compound with a condensed ring (specifically, rubrene) is doped to a hole injecting layer.

According to Document 4, a red emitting layer is disposed at a cathode side of a blue emitting layer, the blue emitting layer being on an anode side and primarily emitting light.

Effects of these arrangements are disclosed to be driving stability and an extended lifetime of an OELD.

According to the configurations disclosed in the above Documents, however, it is inevitable that manufacture steps be complicated in order to provide an extra layer other than an emitting layer and a charge transporting layer.

Now, a single emitting layer contains a plurality of dopants according to Document 5 (JP-A-2002-038140).

Listed as a plurality of dopants are three of the kind, namely (i) an exciton trap dopant, (ii) a hole trap dopant, and (iii) a luminescence dopant.

In an example disclosed therein, tris(8-quinolinol)aluminum (Alq) complex constitutes a host, to which (i) 5% of rubrene is doped as an exciton trap dopant, (ii) 5% of 4,4′-bis(N-(1-naphthyl)-N-phenylamino)biphenyl (abbreviated to NPD) is doped as a hole trap dopant, and (iii) 2% of DCJTB is doped as a luminescence dopant. It is disclosed that serviceable life is extended as an effect of the arrangement.

However, in the OELD disclosed in Document 5, the amount of the exciton trap dopants and the hole trap dopants are so large that that the exciton trap dopants and the hole trap dopants themselves emit light as a matter of course.

It results in deterioration of color purity of the color emission of the luminescence dopant.

Moreover, it is very difficult to form a film of an emitting layer from a host material and three dopant materials, which add up to a total of four materials.

In addition, if film forming is conducted by vapor-deposition as disclosed in the example in Document 5, it is difficult for the four materials vaporized to be simultaneously vapor-deposited entirely at a uniform concentration. Further, film-forming by vapor deposition is not practical, since partial unevenness in the concentration and therefore unevenness in luminescence cannot be avoided.

### SUMMARY OF THE INVENTION

An object of the present invention is to provide an organic electroluminescence device that maintains color purity, allows practical manufacture steps, and possesses a long lifetime.

An organic electroluminescence device according to an aspect of the present invention includes: an anode; a cathode; and an emitting layer interposed between the anode and the cathode, in which the emitting layer contains a host, a first dopant, and a second dopant, a luminous intensity of the first dopant is twelve times as great as a luminous intensity of the second dopant or greater, and the emitting layer is formed by a coating process.

With this arrangement, the second dopant is doped to the emitting layer in addition to the first dopant that primarily emits light.

The luminous intensity of the second dopant is very low compared to that of the first dopant for primarily emitting light. Therefore, the luminescence of the second dopant does not deteriorate color purity of emission of the organic electroluminescence device as a whole, so that color purity of emission of the organic electroluminescence device is maintained.

Although the second dopant does not contribute to color emission, a small amount of the second dopant contributes to an extended life of the organic electroluminescence device.

It should be noted that the luminous intensity of the dopant refers to luminescence components from the dopant in the electroluminescence luminescence spectrum obtained when electricity runs through.

In general, a content of the first dopant contained in the emitting layer needs to be more than that of the second dopant in the emitting layer in order to determine the luminous intensity of the first dopant to be higher than that of the second dopant. Also, when a luminous peak wavelength of the first dopant is shorter than that of the second dopant, the second dopant, rather than the first dopant, is likely to emit light on account of transfer of luminous energy of the first dopant to the second dopant or on account of absorption and reemission of light.

By appropriately decreasing a content of the second dopant, for example, the ratio of the luminous intensity of the first dopant to that of the second dopant can be put twelve times or larger.

In the above arrangement, the emitting layer is formed by a coating process.

More specifically, a host material, a first dopant material, and a second dopant material, each in a predetermined amount, are dissolved in a solvent to provide an organic-electroluminescent-material-containing solution. The organic-electroluminescent-material-containing solution is dropped onto a substrate, a base layer or the like, where the solvent is evaporated to leave an emitting layer formed.

With this process, an emitting layer in which the first dopant and a small amount of the second dopant are evenly dispersed can be easily formed.

Conventionally, since vapor deposition has been employed for forming an emitting layer, it was difficult for a plurality of dopants with different concentrations to be simultaneously and evenly deposited into a single layer.

Here, if a concentration of each of the plurality of the dopants is increased (e.g., 1% by mass or more), the layer can be evenly formed by vapor deposition, but in this case, the luminous intensity of the second dopant is also increased to deteriorate color purity of light emission of the organic electroluminescence device as a whole. In other words, with vapor deposition, which has been a conventional forming process, it has been impossible to put the ratio of the luminous intensities of the first dopant and the second dopant doped in an emitting layer at twelve times or larger.

Thus, a secondary layer that contains a small amount of the second dopant has conventionally been provided in addition to the emitting layer that contains the first dopant. In this case, however, the increased number of layers in an organic electroluminescence device not only complicates manufacture steps but also decreases the light acquisition efficiency.

In other words, it has been difficult to utilize a plurality of dopants without increasing layers and deteriorating color purity.

According to the aspect of the invention, since a coating process is employed in the film-forming steps, the mixing ratio of materials can be accurately controlled, and in addition, a material mixed in a small amount can be evenly dispersed in the film.

Thus, the luminous intensity of the second dopant can be limited to a value that does not affect the color emission of the first dopant.

Therefore, according to the aspect of the present invention, a plurality of dopants can be utilized to extend a lifetime of an organic electroluminescence device, without deteriorating color purity or increasing layers.

In the aspect of the present invention, it is preferable that a content of the second dopant be 0.001% by mass to 0.5% by mass.

Such reduction of a content of the second dopant enables to reduce the luminous intensity of the second dopant to put the ratio of the luminous intensities of the first dopant and the second dopant at twelve times or larger.

In the aspect of the present invention, it is preferable that an energy gap of the first dopant be greater than an energy gap of the second dopant.

For example, an energy gap of the first dopant may be 2.9 eV or more, and an energy gap of the second dopant may be below 2.9 eV.

With this arrangement, the emitting layer contains a small amount of the second dopant that has a small energy gap.

Here, the second dopant serves as an electric charge trap that traps electric charge (i.e. electron or hole) excessively injected to the emitting layer to adjust electric charge balance.

As a result, an organic electroluminescence device can obtain an improved luminous property as well as an extended lifetime.

Conventionally, poor injection balance of electric charge has caused either of electrons and holes to be excessively injected to the emitting layer, resulting in a lowered luminous efficiency and a shortened lifetime.

Assumedly, this is because when the injection balance of electric charge is improper, an emitting region is misaligned toward an anode side or a cathode side of the emitting layer, or the electric charge even passes through the emitting layer.

When the emitting region is misaligned owing to unbalanced electric charge, sufficient performance of the luminescent material is not sufficiently exhibited.

Moreover, if the electric charge passes through not only the emitting layer but also the hole transporting layer or the electron transporting layer, the electric charge recombines in the hole transporting zone or the electron transporting zone, which causes an extreme deterioration of the material, thus shortening the lifetime thereof.

Here, according to the aspect of the present invention, balance of the electric charge in the emitting layer can be adjusted by the second dopant. Accordingly, the recombination region can be controlled to be disposed at the optimum region to maintain the luminous efficiency and to extend life as well.

In this case, since the content of the second dopant is small, the color emission of the organic electroluminescence device as a whole is not affected, so that the color purity can be maintained.

In order not to have the emission of the second dopant influence the color emission of the first dopant, it is preferable that the content of the second dopant be small. On the other hand, in order to have the second dopant properly function as the electric charge trap, the materials have to be properly concentrated.

For this reason, the content of the second dopant may preferably be 0.001% to 0.5% by mass, may further preferably be 0.005% to 0.4% by mass, and may still further preferably be 0.001% to 0.1% by mass.

Here, an energy gap refers to a difference between conductive level and covalent electron level, which can, for example, be defined by a value measured from an absorption end of an absorption spectrum in benzene. Specifically, the absorption spectrum is measured with a commercially available ultraviolet-visible spectrophotometer, and the energy gap is calculated from a wavelength at which the absorption spectrum appears.

It should be noted that an energy gap need not be based on the above definition, but may be any value capable of being defined as an energy gap without diverting from the inventive concept of the present invention.

In the aspect of the present invention, it is preferable that the electroluminescence device further includes an electron transporting layer interposed between the emitting layer and the cathode, in which an affinity level of the second dopant is greater than an affinity level of the host by 0.2 eV or more, and electron mobility of the electron transporting layer is 10⁻⁴ cm²/Vs or greater at an electric intensity of 0.25 mV/cm.

With this arrangement, the drive voltage of the organic electroluminescence device can be lowered by using an electron transporting layer having high electron mobility.

Also, exciton energy by electrons and holes injected to the emitting layer is transferred to the first dopant from the host and acquired as light emission.

Here, if an electron transporting layer having an excellent electron transporting performance is employed, the drive voltage can be reduced. However, at the same time, electrons may be injected to the emitting layer in excess.

Once the excessively injected electrons reach a hole transporting layer (or an anode), the hole transporting layer (or the anode) is deteriorated, thereby shortening the lifetime of the organic electroluminescence device.

With regard to the problem, the present invention includes a second dopant having an affinity level higher than that of a host. In this way, the second dopant functions as an electron trap. The second dopant traps the excessively injected electrons to adjust the electron charge balance.

As a result, while the voltage is lowered by an electron transport material having high electron mobility, the lifetime can also be extended.

Here, an affinity level Af (i.e. electron affinity) refers to ejected or absorbed energy when an electron is given to a molecule of a material, which is defined to be positive in the case of ejection and negative in the case of absorption.

The affinity level Af is defined by an ionization potential Ip and an optical energy gap Eg as follows.

Af=Ip−Eg

Here, the ionization potential Ip refers to energy necessary for a compound of each material to remove electrons to ionize, for which a value measured with an ultraviolet ray photoelectron spectrometer (AC-3 manufactured by Riken Keiki Co., Ltd.).

It should be noted that an affinity level need not be based on the above definition, but may be any value capable of being defined as an affinity level without diverting from the inventive concept of the present invention.

Also, electron mobility can, for example, be measured by a TOF (Time-Of-Flight) method, but may be measured by other methods.

In the aspect of the present invention, it is preferable that the electron transporting layer contain a nitrogen-containing heterocyclic derivative represented by a following formula (1),

HAr-L-Ar¹—Ar² (1)

where HAr is a substituted or unsubstituted nitrogen-containing heterocyclic group having 3 to 40 carbons;

L is a single bond, a substituted or unsubstituted arylene group having 6 to 60 carbons, a substituted or unsubstituted heteroarylene group having 3 to 60 carbons, or a substituted or unsubstituted fluorenylene group;

Ar¹ is a substituted or unsubstituted divalent aromatic hydrocarbon group having 6 to 60 carbons; and

Ar² is a substituted or unsubstituted aryl group having 6 to 60 carbons or a substituted or unsubstituted heteroaryl group having 3 to 60 carbons.)

These materials allow an electron transporting layer having an excellent electron transporting performance.

Incidentally, a third dopant may be doped to the host of the emitting layer in addition to the first and second dopants.

### BRIEF DESCRIPTION OF THE DRAWINGS

FIG. 1 shows an example of an organic electroluminescence device according to an embodiment of the present invention.

### DETAILED DESCRIPTION OF PREFERRED EMBODIMENT(S)

Embodiments of the present invention will be described below.

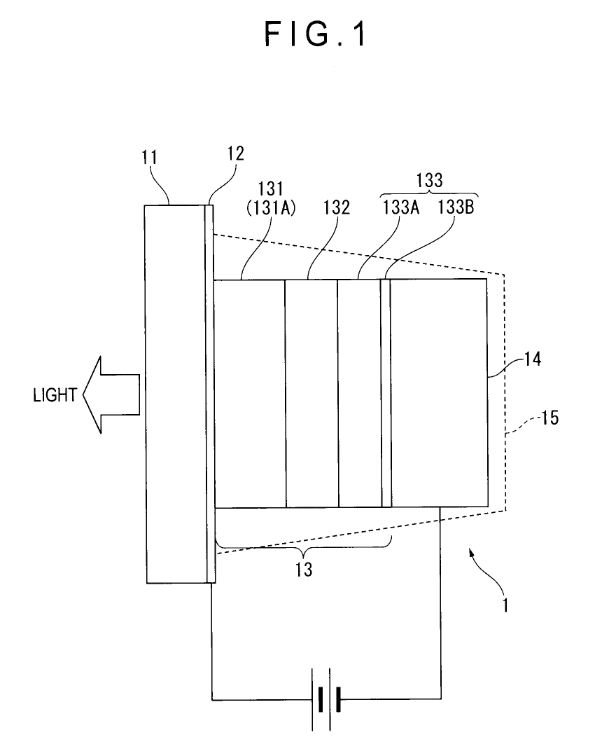

FIG. 1 shows an example of an organic electroluminescence device (hereafter abbreviated to OELD).

An OELD 1 constitutes a pixel of a display panel, and voltage applied to the OELD 1 is controlled by a drive circuit (not shown) to control light-emitting operation of the OELD 1.

The OELD 1 includes an anode 12, an organic layer 13, and a cathode 14, which are layered in this order starting from a substrate 11, and is covered by a protection film 15 to be airtightly protected.

The embodiment is of a bottom emission type in which emitting light is acquired from a side of the transparent glass substrate 11, and a transparent electrode is provided as an anode 12 on the glass substrate 11.

Provided opposite to the anode 12 with the organic layer 13 inbetween is a light reflective cathode 14 made of Al or the like.

A hole transporting zone 131, an emitting layer 132, and an electron transporting zone 133 are provided to the organic layer 13 in this order starting from the side of the anode 12.

The hole transporting zone 131, which transports holes injected from the anode 12 and injects the holes to the emitting layer 132, is formed by a hole transporting layer 131A.

Ionization energy of the hole transporting layer 131A (the hole transporting zone 131) may preferably be small. For example, it is preferable that ionization energy normally be 5.5 eV or less.

A material that transports holes at a lower electric intensity is preferable for the hole transporting layer 131A (the hole transporting zone 131). For example, it is preferable that the rate be at least 10⁻⁴ cm²/V·second when an electric field of 10⁴ to 10⁶ V/cm is applied. Specific materials will be described later.

Holes and electrons are injected to the emitting layer 132 when an electric field is applied (electric charge injecting function), the emitting layer 132 transports the injected electric charge (the holes and the electrons) by force of electric field (electric charge transporting function), and the emitting layer 132 provides a place for recombination of the holes and the electrons and obtains light emission (light emitting function).

In the embodiment, a host, a first dopant, and a second dopant are provided to the emitting layer 132.

A description on a host material and a dopant material will be given below.

The emitting layer 132 includes the host material, which constitutes most of the emitting layer 132, and the dopant material, which is doped to the host material.

The host material occupies most (e.g. 80% or more) of the emitting layer 132, which may, for example, be 30 nm to 100 nm thick.

For example, a ratio at which the dopant material is doped to the host material (the dopant material/the host material) is set to be 0.01% to 20% by mass.

Energy transfer or the like from the host material to the dopant material occurs, and the dopant material conducts light emitting Hfunction.

In the embodiment, two kinds of dopants, the first dopant and the second dopant, are doped to the host.

Most of light emission attributes to the first dopant, whose luminous intensity I₁ is twelve times larger than the luminous intensity I₂ of the second dopant.

In order to provide an OELD 1 that performs good shortwave light emission, the first dopant that primarily emits light may be, for example, a material that performs blue emission, and possesses, for example, an energy gap of 2.9 eV or more.

The luminous intensity I₂ of the second dopant, a small amount of which is contained in the emitting layer 132, is low.

In order to provide a low luminous intensity I₂ of the second dopant, the second dopant is contained at an amount of 0.001 mass % to 0.5 mass % of the emitting layer 132.

The second dopant has a smaller energy gap than that of the first dopant. If an energy gap of the first dopant is 2.9 eV or more, an energy gap of the second gap is less than 2.9 eV.

In order to provide a second dopant that functions as an electron trap, an affinity level Af₂ of the second dopant is larger than an affinity level Af_{H} of the host by 0.2 eV or more.

Next, a coating process is employed to form the emitting layer 132 containing a small amount of the second dopant as described above.

More specifically, the host material, the first dopant material, and the second dopant material, each in a predetermined amount, is dissolved in a solvent to provide an organic-electroluminescent-material-containing solution.

A film is then formed of the solution on a base layer by spin coating or the like.

When a coating method that uses a solution is employed, a containing ratio of the three materials, that is, the host, the first dopant, and the second dopant can be precisely controlled.

In particular, the containing ratio of the small amount of the second dopant can be precisely controlled, thus enabling formation of a film in which the second dopant is evenly dispersed.

Now, examples of compounds that constitute the emitting layer 132 will be shown.

A material already known to possess a long life and light emitting property can be used for the host.

For example, a material represented by the following formula (2) may preferably be used for the host material.

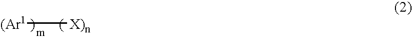

In the above formula (2), Ar¹ represents an aromatic ring whose number of carbon atoms forming the aromatic ring is 6 to 50 and X represents a substituent group.

The sign m refers to an integer from 1 to 5, and the sign n refers to an integer from 0 to 6. If m≧2, Ar¹s can be the same or different. If n≧2, X can be the same or different.

To be specific, Ar¹ may be a phenyl ring, naphthyl ring, anthracene ring, biphenylene ring, azulene ring, acenaphthylene ring, fluorene ring, phenanthrene ring, fluoranthene ring, acephenanthrylene ring, triphenylene ring, pyrene ring, chrysene ring, naphthacene ring, picene ring, perylene ring, pentaphene ring, pentacene ring, tetraphenylene ring, hexaphene ring, hexacene ring, rubicene ring, coronene ring, trinaphthylene ring, or the like.

Ar¹ may preferably be a phenyl ring, naphthyl ring, anthracene ring, acenaphthylene ring, fluorene ring, phenanthrene ring, fluoranthene ring, triphenylene ring, pyrene ring, chrysene ring, perylene ring, trinaphthylene ring, or the like.

Ar¹ may further preferably be a phenyl ring, naphthyl ring, anthracene ring, fluorene ring, phenanthrene ring, fluoranthene ring, pyrene ring, chrysene ring, perylene ring, or the like.

Also to be specific, X may be a substituted or unsubstituted aromatic group having 6 to 50 ring carbon atoms, substituted or unsubstituted aromatic heterocyclic group whose number of atoms forming the aromatic ring is 5 to 50, substituted or unsubstituted alkyl group having 1 to 50 carbons, substituted or unsubstituted alkoxy group having 1 to 50 carbons, substituted or unsubstituted aralkyl group having 1 to 50 carbons, substituted or unsubstituted aryloxy group having 5 to 50 ring atoms, substituted or unsubstituted arylthio group having 5 to 50 ring atoms, substituted or unsubstituted carboxyl group having 1 to 50 carbons, substituted or unsubstituted styryl group, halogen group, cyano group, nitro group, hydroxyl group, or the like.

Examples of the substituted or unsubstituted aromatic group having 6 to 50 ring carbon atoms are a phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl-group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, 4″-t-butyl-p-terphenyl-4-yl group, 2-fluorenyl group, 9,9-dimethyl-2-fluorenyl group, 3-fluoranthenyl group, and the like.

The substituted or unsubstituted aromatic group having 6 to 50 ring carbon atoms may preferably be a phenyl group, 1-naphthyl group, 2-naphthyl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, o-tolyl group, m-tolyl group, p-tolyl group, p-t-butylphenyl group, 2-fluorenyl group, 9,9-dimethyl-2-fluorenyl group, 3-fluoranthenyl group, or the like.

Examples of the substituted or unsubstituted aromatic heterocyclic group having 5 to 50 ring atoms include a 1-pyrrolyl group, 2-pyrrolyl group, 3-pyrrolyl group, pyrazinyl group, 2-pyridinyl group, 3-pyridinyl group, 4-pyridinyl group, 1-indolyl group, 2-indolyl group, 3-indolyl group, 4-indolyl group, 5-indolyl group, 6-indolyl group, 7-indolyl group, 1-isoindolyl group, 2-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 9-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthrolin-2-yl group, 1,7-phenanthrolin-3-yl group, 1,7-phenanthrolin-4-yl group, 1,7-phenanthrolin-5-yl group, 1,7-phenanthrolin-6-yl group, 1,7-phenanthrolin-8-yl group, 1,7-phenanthrolin-9-yl group, 1,7-phenanthrolin-10-yl group, 1,8-phenanthrolin-2-yl group, 1,8-phenanthrolin-3-yl group, 1,8-phenanthrolin-4-yl group, 1,8-phenanthrolin-5-yl group, 1,8-phenanthrolin-6-yl group, 1,8-phenanthrolin-7-yl group, 1,8-phenanthrolin-9-yl group, 1,8-phenanthrolin-10-yl group, 1,9-phenanthrolin-2-yl group, 1,9-phenanthrolin-3-yl group, 1,9-phenanthrolin-4-yl group, 1,9-phenanthrolin-5-yl group, 1,9-phenanthrolin-6-yl group, 1,9-phenanthrolin-7-yl group, 1,9-phenanthrolin-8-yl group, 1,9-phenanthrolin-10-yl group, 1,10-phenanthrolin-2-yl group, 1,10-phenanthrolin-3-yl group, 1,10-phenanthrolin-4-yl group, 1,10-phenanthrolin-5-yl group, 2,9-phenanthrolin-1-yl group, 2,9-phenanthrolin-3-yl group, 2,9-phenanthrolin-4-yl group, 2,9-phenanthrolin-5-yl group, 2,9-phenanthrolin-6-yl group, 2,9-phenanthrolin-7-yl group, 2,9-phenanthrolin-8-yl group, 2,9-phenanthrolin-10-yl group, 2,8-phenanthrolin-1-yl group, 2,8-phenanthrolin-3-yl group, 2,8-phenanthrolin-4-yl group, 2,8-phenanthrolin-5-yl group, 2,8-phenanthrolin-6-yl group, 2,8-phenanthrolin-7-yl group, 2,8-phenanthrolin-9-yl group, 2,8-phenanthrolin-10-yl group, 2,7-phenanthrolin-1-yl group, 2,7-phenanthrolin-3-yl group, 2,7-phenanthrolin-4-yl group, 2,7-phenanthrolin-5-yl group, 2,7-phenanthrolin-6-yl group, 2,7-phenanthrolin-8-yl group, 2,7-phenanthrolin-9-yl group, 2,7-phenanthrolin-10-yl group, 1-phenazinyl group, 2-phenazinyl group, 1-phenothiazinyl group, 2-phenothiazinyl group, 3-phenothiazinyl group, 4-phenothiazinyl group, 10-phenothiazinyl group, 1-phenoxazinyl group, 2-phenoxazinyl group, 3-phenoxazinyl group, 4-phenoxazinyl group, 10-phenoxazinyl group, 2-oxazolyl group, 4-oxazolyl group, 5-oxazolyl group, 2-oxadiazolyl group, 5-oxadiazolyl group, 3-furazanyl group, 2-thienyl group, 3-thienyl group, 2-methylpyrrol-1-yl group, 2-methylpyrrol-3-yl group, 2-methylpyrrol-4-yl group, 2-methylpyrrol-5-yl group, 3-methylpyrrol-1-yl group, 3-methylpyrrol-2-yl group, 3-methylpyrrol-4-yl group, 3-methylpyrrol-5-yl group, 2-t-butylpyrrol-4-yl group, 3-(2-phenylpropyl)pyrrol-1-yl group, 2-methyl-1-indolyl group, 4-methyl-1-indolyl group, 2-methyl-3-indolyl group, 4-methyl-3-indolyl group, 2-t-butyl-1-indolyl group, 4-t-butyl-1-indolyl group, 2-t-butyl-3-indolyl group, 4-t-butyl-3-indolyl group, and the like.

Examples of the substituted or unsubstituted alkyl group having 1 to 50 carbons include a methyl group, ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroxyethyl group, 1,3-dihydroxyisopropyl group, 2,3-dihydroxy-t-butyl group, 1,2,3-trihydroxypropyl group, chloromethyl group, 1-chloroethyl group, 2-chloroethyl group, 2-chloroisobutyl group, 1,2-dichloroethyl group, 1,3-dichloroisopropyl group, 2,3-dichloro-t-butyl group, 1,2,3-trichloropropyl group, bromomethyl group, 1-bromoethyl group, 2-bromoethyl group, 2-bromoisobutyl group, 1,2-dibromoethyl group, 1,3-dibromoisopropyl group, 2,3-dibromo-t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo-t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino-t-butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group, 2,3-dicyano-t-butyl group, 1,2,3-tricyanopropyl group, nitromethyl group, 1-nitroethyl group, 2-nitroethyl group, 2-nitroisobutyl group, 1,2-dinitroethyl group, 1,3-dinitroisopropyl group, 2,3-dinitro-t-butyl group, 1,2,3-trinitropropyl group, cyclopropyl group, cyclobutyl group, cyclopentyl group, cyclohexyl group, 4-methylcyclohexyl group, 1-adamantyl group, 2-adamantyl group, 1-norbornyl group, 2-norbornyl group, and the like.

The substituted or unsubstituted alkoxy group having 1 to 50 carbons is represented by —OY. Examples of Y include a methyl group, ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroxyethyl group, 1,3-dihydroxyisopropyl group, 2,3-dihydroxy-t-butyl group, 1,2,3-trihydroxypropyl group, chloromethyl group, 1-chloroethyl group, 2-chloroethyl group, 2-chloroisobutyl group, 1,2-dichloroethyl group, 1,3-dichloroisopropyl group, 2,3-dichloro-t-butyl group, 1,2,3-trichloropropyl group, bromomethyl group, 1-bromoethyl group, 2-bromoethyl group, 2-bromoisobutyl group, 1,2-dibromoethyl group, 1,3-dibromoisopropyl group, 2,3-dibromo-t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo-t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino-t-butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group, 2,3-dicyano-t-butyl group, 1,2,3-tricyanopropyl group, nitromethyl group, 1-nitroethyl group, 2-nitroethyl group, 2-nitroisobutyl group, 1,2-dinitroethyl group, 1,3-dinitroisopropyl group, 2,3-dinitro-t-butyl group, 1,2,3-trinitropropyl group, and the like.

Examples of the substituted or unsubstituted aralkyl group having 1 to 50 carbons include benzyl group, 1-phenylethyl group, 2-phenylethyl group, 1-phenylisopropyl group, 2-phenylisopropyl group, phenyl-t-butyl group, α-naphthylmethyl group, 1-α-naphthylethyl group, 2-α-naphthylethyl group, 1-α-naphthylisopropyl group, 2-α-naphthylisopropyl group, β-naphthylmethyl group, 1-β-naphthylethyl group, 2-β-naphthylethyl group, 1-β-naphthylisopropyl group, 2-β-naphthylisopropyl group, 1-pyrrolylmethyl group, 2-(1-pyrrolyl)ethyl group, p-methylbenzyl group, m-methylbenzyl group, o-methylbenzyl group, p-chlorobenzyl group, m-chlorobenzyl group, o-chlorobenzyl group, p-bromobenzyl group, m-bromobenzyl group, o-bromobenzyl group, p-iodobenzyl group, m-iodobenzyl group, o-iodobenzyl group, p-hydroxybenzyl group, m-hydroxybenzyl group, o-hydroxybenzyl group, p-aminobenzyl group, m-aminobenzyl group, o-aminobenzyl group, p-nitrobenzyl group, m-nitrobenzyl group, o-nitrobenzyl group, p-cyanobenzyl group, m-cyanobenzyl group, o-cyanobenzyl group, 1-hydroxy-2-phenylisopropyl group, 1-chloro-2-phenylisopropyl group and the like.

The substituted or unsubstituted aryloxy group having 5 to 50 ring atoms is represented by —OY′. Examples of Y′ include a phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, 4″-t-butyl-p-terphenyl-4-yl group, 2-pyrrolyl group, 3-pyrrolyl group, pyrazinyl group, 2-pyridinyl group, 3-pyridinyl group, 4-pyridinyl group, 2-indolyl group, 3-indolyl group, 4-indolyl group, 5-indolyl group, 6-indolyl group, 7-indolyl group, 1-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, 2-quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthrolin-2-yl group, 1,7-phenanthrolin-3-yl group, 1,7-phenanthrolin-4-yl group, 1,7-phenanthrolin-5-yl group, 1,7-phenanthrolin-6-yl group, 1,7-phenanthrolin-8-yl group, 1,7-phenanthrolin-9-yl group, 1,7-phenanthrolin-10-yl group, 1,8-phenanthrolin-2-yl group, 1,8-phenanthrolin-3-yl group, 1,8-phenanthrolin-4-yl group, 1,8-phenanthrolin-5-yl group, 1,8-phenanthrolin-6-yl group, 1,8-phenanthrolin-7-yl group, 1,8-phenanthrolin-9-yl group, 1,8-phenanthrolin-10-yl group, 1,9-phenanthrolin-2-yl group, 1,9-phenanthrolin-3-yl group, 1,9-phenanthrolin-4-yl group, 1,9-phenanthrolin-5-yl group, 1,9-phenanthrolin-6-yl group, 1,9-phenanthrolin-7-yl group, 1,9-phenanthrolin-8-yl group, 1,9-phenanthrolin-10-yl group, 1,10-phenanthrolin-2-yl group, 1,10-phenanthrolin-3-yl group, 1,10-phenanthrolin-4-yl group, 1,10-phenanthrolin-5-yl group, 2,9-phenanthrolin-1-yl group, 2,9-phenanthrolin-3-yl group, 2,9-phenanthrolin-4-yl group, 2,9-phenanthrolin-5-yl group, 2,9-phenanthrolin-6-yl group, 2,9-phenanthrolin-7-yl group, 2,9-phenanthrolin-8-yl group, 2,9-phenanthrolin-10-yl group, 2,8-phenanthrolin-1-yl group, 2,8-phenanthrolin-3-yl group, 2,8-phenanthrolin-4-yl group, 2,8-phenanthrolin-5-yl group, 2,8-phenanthrolin-6-yl group, 2,8-phenanthrolin-7-yl group, 2,8-phenanthrolin-9-yl group, 2,8-phenanthrolin-10-yl group, 2,7-phenanthrolin-1-yl group, 2,7-phenanthrolin-3-yl group, 2,7-phenanthrolin-4-yl group, 2,7-phenanthrolin-5-yl group, 2,7-phenanthrolin-6-yl group, 2,7-phenanthrolin-8-yl group, 2,7-phenanthrolin-9-yl group, 2,7-phenanthrolin-10-yl group, 1-phenazinyl group, 2-phenazinyl group, 1-phenothiazinyl group, 2-phenothiazinyl group, 3-phenothiazinyl group, 4-phenothiazinyl group, 1-phenoxazinyl group, 2-phenoxazinyl group, 3-phenoxazinyl group, 4-phenoxazinyl group, 2-oxazolyl group, 4-oxazolyl group, 5-oxazolyl group, 2-oxadiazolyl group, 5-oxadiazolyl group, 3-furazanyl group, 2-thienyl group, 3-thienyl group, 2-methylpyrrol-1-yl group, 2-methylpyrrol-3-yl group, 2-methylpyrrol-4-yl group, 2-methylpyrrol-5-yl group, 3-methylpyrrol-1-yl group, 3-methylpyrrol-2-yl group, 3-methylpyrrol-4-yl group, 3-methylpyrrol-5-yl group, 2-t-butylpyrrol-4-yl group, 3-(2-phenylpropyl)pyrrol-1-yl group, 2-methyl-1-indolyl group, 4-methyl-1-indolyl group, 2-methyl-3-indolyl group, 4-methyl-3-indolyl group, 2-t-butyl-1-indolyl group, 4-t-butyl-1-indolyl group, 2-t-butyl-3-indolyl group, 4-t-butyl-3-indolyl group, and the like.

The substituted or unsubstituted arylthio group having 5 to 50 ring atoms is represented by —SY″. Examples of Y″ include a phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, 4″-t-butyl-p-terphenyl-4-yl group, 2-pyrrolyl group, 3-pyrrolyl group, pyrazinyl group, 2-pyridinyl group, 3-pyridinyl group, 4-pyridinyl group, 2-indolyl group, 3-indolyl group, 4-indolyl group, 5-indolyl group, 6-indolyl group, 7-indolyl group, 1-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, 2-quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthrolin-2-yl group, 1,7-phenanthrolin-3-yl group, 1,7-phenanthrolin-4-yl group, 1,7-phenanthrolin-5-yl group, 1,7-phenanthrolin-6-yl group, 1,7-phenanthrolin-8-yl group, 1,7-phenanthrolin-9-yl group, 1,7-phenanthrolin-10-yl group, 1,8-phenanthrolin-2-yl group, 1,8-phenanthrolin-3-yl group, 1,8-phenanthrolin-4-yl group, 1,8-phenanthrolin-5-yl group, 1,8-phenanthrolin-6-yl group, 1,8-phenanthrolin-7-yl group, 1,8-phenanthrolin-9-yl group, 1,8-phenanthrolin-10-yl group, 1,9-phenanthrolin-2-yl group, 1,9-phenanthrolin-3-yl group, 1,9-phenanthrolin-4-yl group, 1,9-phenanthrolin-5-yl group, 1,9-phenanthrolin-6-yl group, 1,9-phenanthrolin-7-yl group, 1,9-phenanthrolin-8-yl group, 1,9-phenanthrolin-10-yl group, 1,10-phenanthrolin-2-yl group, 1,10-phenanthrolin-3-yl group, 1,10-phenanthrolin-4-yl group, 1,10-phenanthrolin-5-yl group, 2,9-phenanthrolin-1-yl group, 2,9-phenanthrolin-3-yl group, 2,9-phenanthrolin-4-yl group, 2,9-phenanthrolin-5-yl group, 2,9-phenanthrolin-6-yl group, 2,9-phenanthrolin-7-yl group, 2,9-phenanthrolin-8-yl group, 2,9-phenanthrolin-10-yl group, 2,8-phenanthrolin-1-yl group, 2,8-phenanthrolin-3-yl group, 2,8-phenanthrolin-4-yl group, 2,8-phenanthrolin-5-yl group, 2,8-phenanthrolin-6-yl group, 2,8-phenanthrolin-7-yl group, 2,8-phenanthrolin-9-yl group, 2,8-phenanthrolin-10-yl group, 2,7-phenanthrolin-1-yl group, 2,7-phenanthrolin-3-yl group, 2,7-phenanthrolin-4-yl group, 2,7-phenanthrolin-5-yl group, 2,7-phenanthrolin-6-yl group, 2,7-phenanthrolin-8-yl group, 2,7-phenanthrolin-9-yl group, 2,7-phenanthrolin-10-yl group, 1-phenazinyl group, 2-phenazinyl group, 1-phenothiazinyl group, 2-phenothiazinyl group, 3-phenothiazinyl group, 4-phenothiazinyl group, 1-phenoxazinyl group, 2-phenoxazinyl group, 3-phenoxazinyl group, 4-phenoxazinyl group, 2-oxazolyl group, 4-oxazolyl group, 5-oxazolyl group, 2-oxadiazolyl group, 5-oxadiazolyl group, 3-furazanyl group, 2-thienyl group, 3-thienyl group, 2-methylpyrrol-1-yl group, 2-methylpyrrol-3-yl group, 2-methylpyrrol-4-yl group, 2-methylpyrrol-5-yl group, 3-methylpyrrol-1-yl group, 3-methylpyrrol-2-yl group, 3-methylpyrrol-4-yl group, 3-methylpyrrol-5-yl group, 2-t-butylpyrrol-4-yl group, 3-(2-phenylpropyl)pyrrol-1-yl group, 2-methyl-1-indolyl group, 4-methyl-1-indolyl group, 2-methyl-3-indolyl group, 4-methyl-3-indolyl group, 2-t-butyl-1-indolyl group, 4-t-butyl-1-indolyl group, 2-t-butyl-3-indolyl group, 4-t-butyl-3-indolyl group, and the like.

The substituted or unsubstituted carboxyl group having 1 to 50 carbons is represented by —COOZ. Examples of Z include a methyl group, ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroxyethyl group, 1,3-dihydroxyisopropyl group, 2,3-dihydroxy-t-butyl group, 1,2,3-trihydroxypropyl group, chloromethyl group, 1-chloroethyl group, 2-chloroethyl group, 2-chloroisobutyl group, 1,2-dichloroethyl group, 1,3-dichloroisopropyl group, 2,3-dichloro-t-butyl group, 1,2,3-trichloropropyl group, bromomethyl group, 1-bromoethyl group, 2-bromoethyl group, 2-bromoisobutyl group, 1,2-dibromoethyl group, 1,3-dibromoisopropyl group, 2,3-dibromo-t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo-t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino-t-butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group, 2,3-dicyano-t-butyl group, 1,2,3-tricyanopropyl group, nitromethyl group, 1-nitroethyl group, 2-nitroethyl group, 2-nitroisobutyl group, 1,2-dinitroethyl group, 1,3-dinitroisopropyl group, 2,3-dinitro-t-butyl group, 1,2,3-trinitropropyl group, and the like.

Examples of the substituted or unsubstituted styryl group include a 2-phenyl-1-vinyl group, 2,2-diphenyl-1-vinyl group, 1,2,2-triphenyl-1-vinyl group, and the like.

Examples of the halogen group include fluorine, chlorine, bromine, iodine, and the like.

1 or 2 is preferable for m, and one of 0 to 4 is preferable for n.

Specific examples of the above general formula (2) will be shown below.

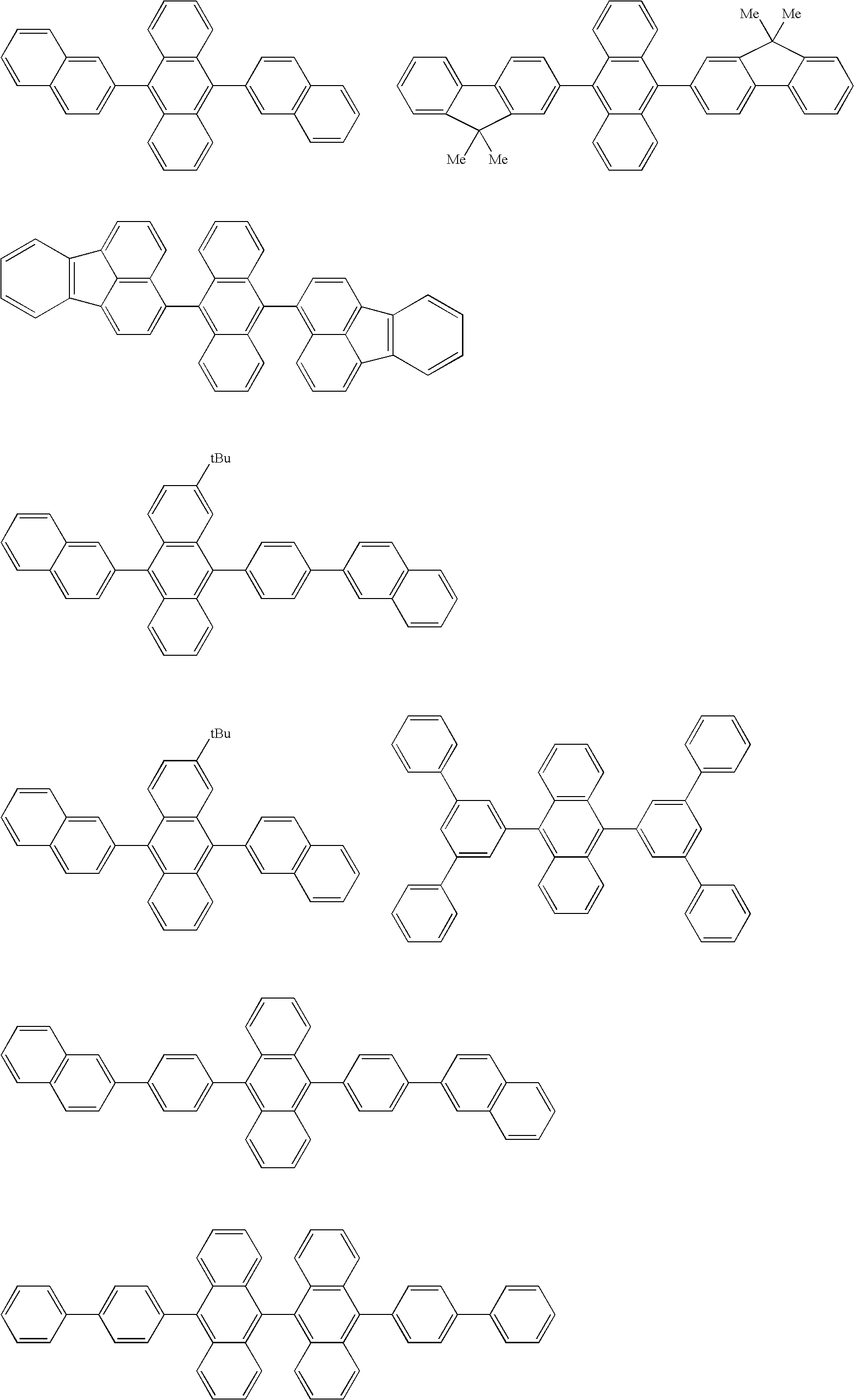

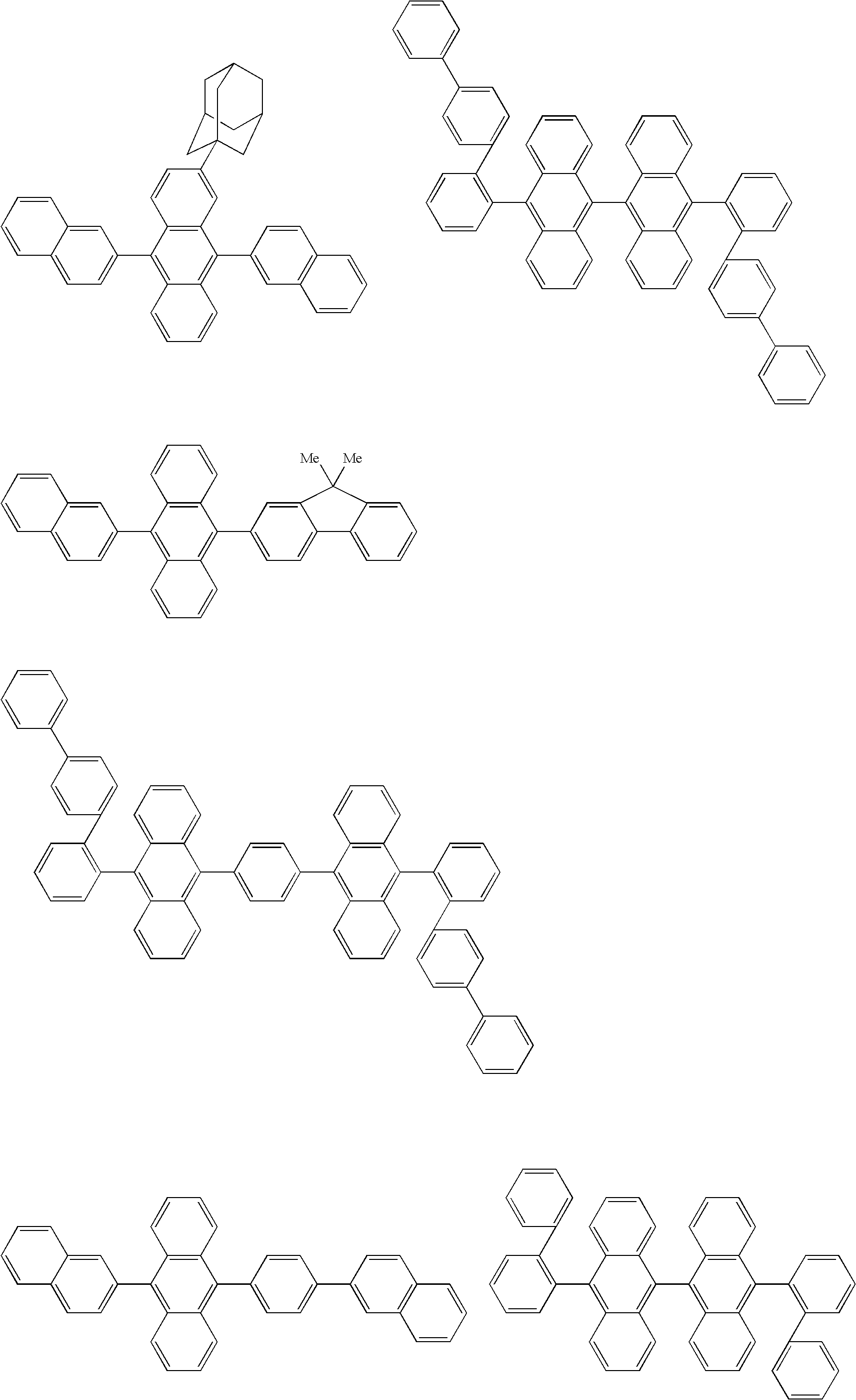

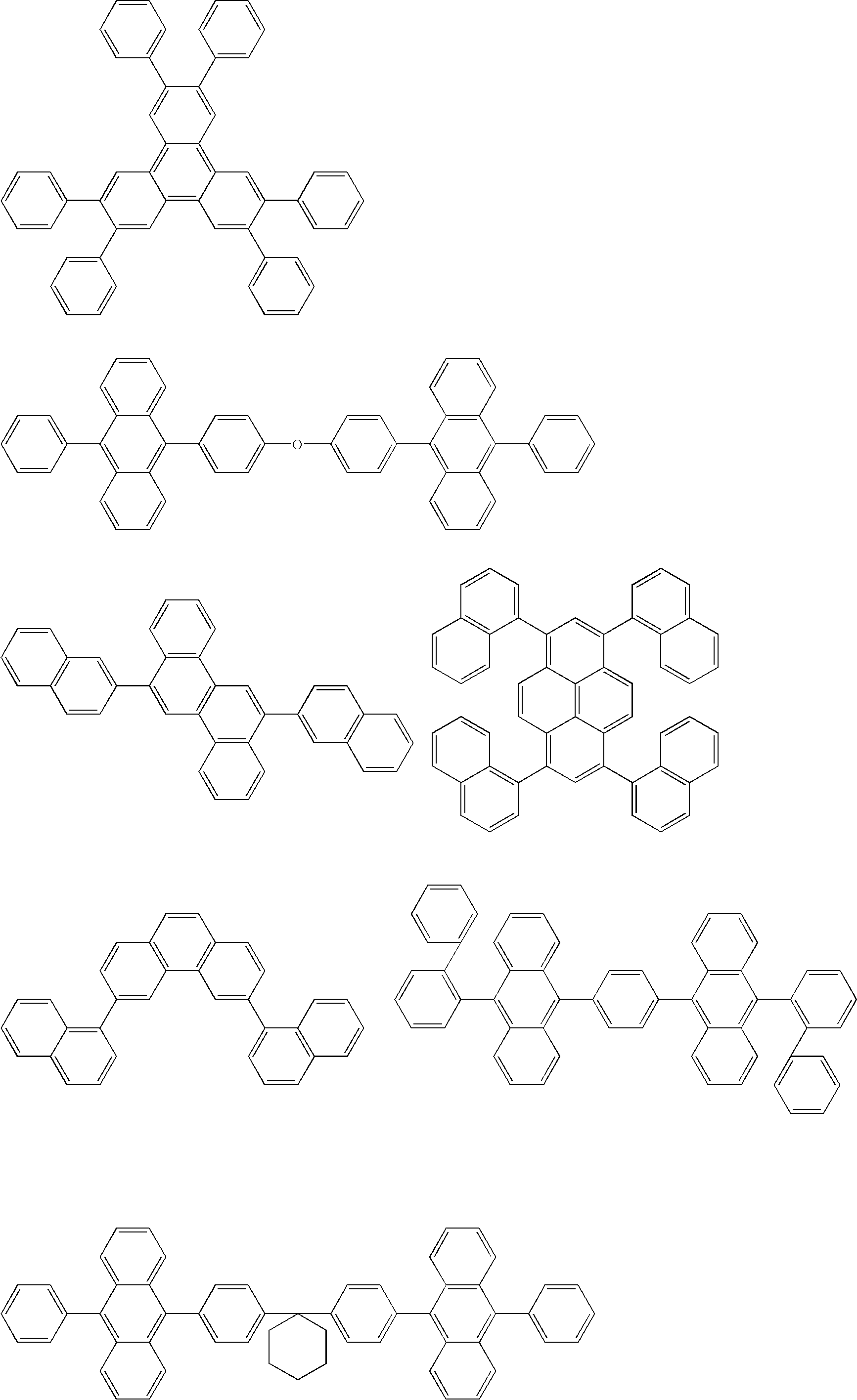

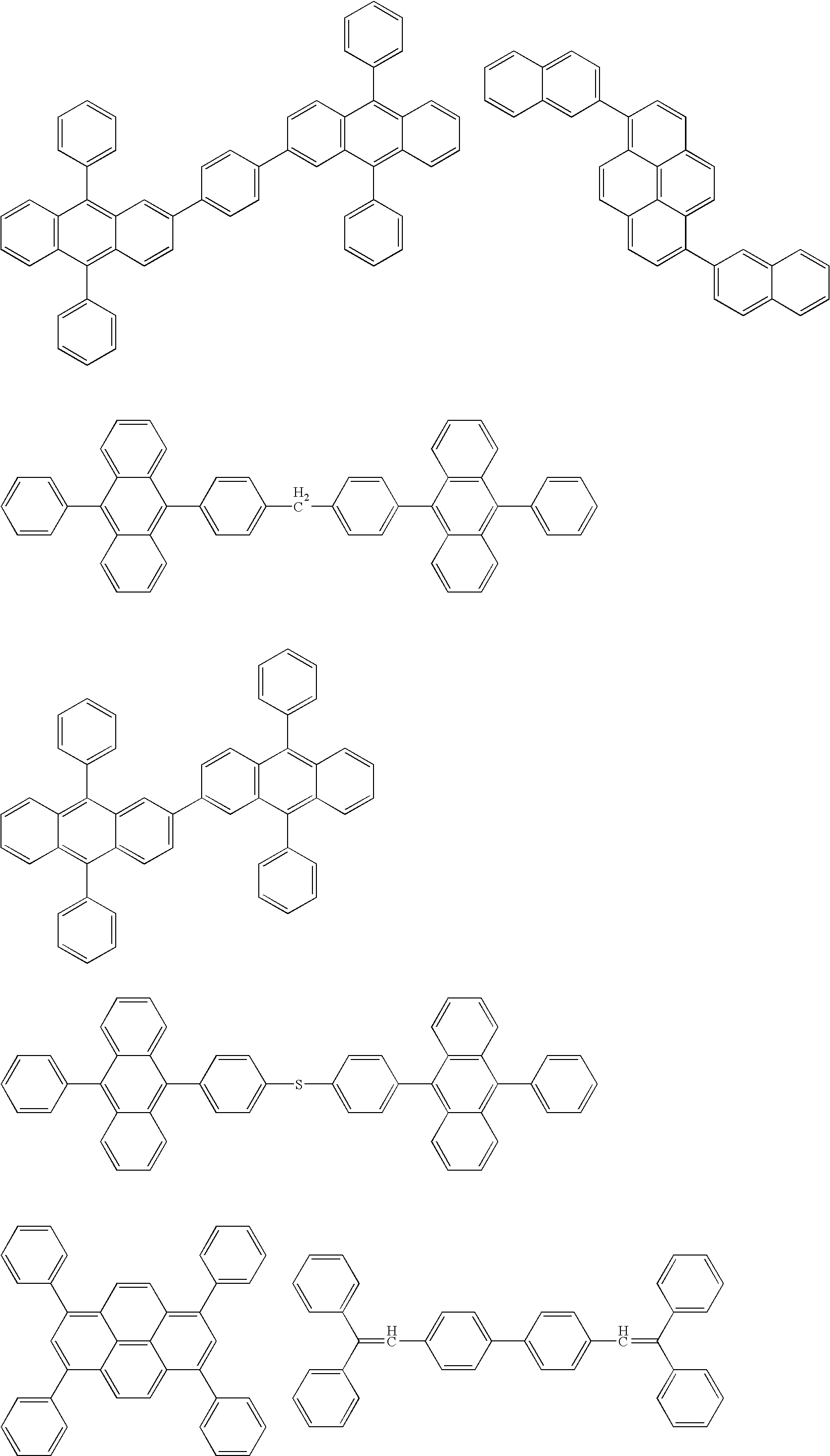

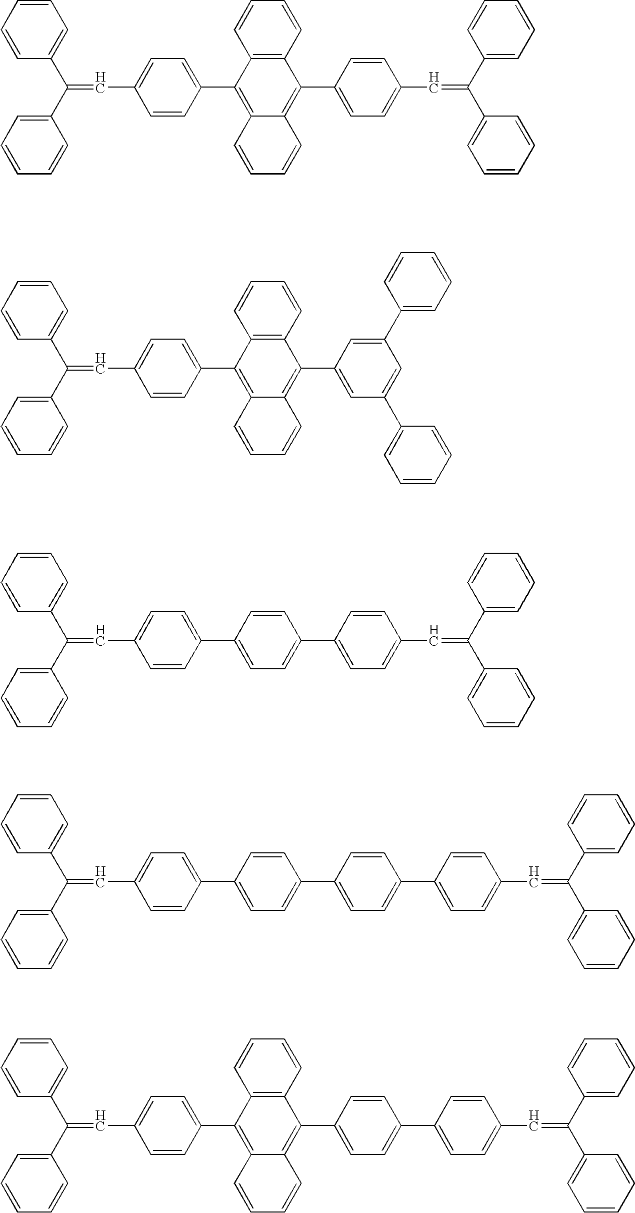

An anthracene derivative represented by the following formula (3) is also suitable for the host.

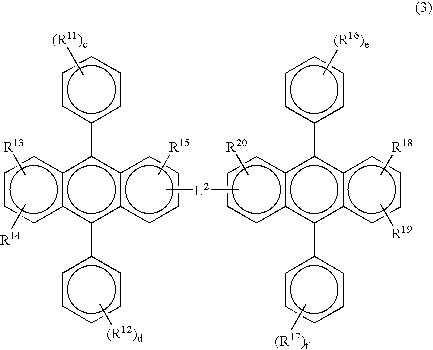

In the above formula (3), each of R¹¹ to R²⁰ independently represents a hydrogen atom, alkyl group, cycloalkyl group, aryl group, alkoxyl group aryloxy group, alkylamino group, arylamino group or substitutable heterocyclic group. When c, d, e, and f, each of which represents an integer from 1 to 5, are 2 or larger: each of a plurality of R¹¹ may be identical to or different from each other, each of a plurality of R¹² may be identical to or different from each other, each of a plurality of R¹⁶ may be identical to or different from each other, and each of a plurality of R¹⁷ may be identical to or different from each other; each of the plurality of R¹¹ may combine with each other to form a ring, each of the plurality of R¹² may combine with each other to form a ring, each of the plurality of R¹⁶ may combine with each other to form a ring, and each of the plurality of R¹⁷ may combine with each other to form a ring; and R¹³ and R¹⁴ may combine with each other to form a ring, and R¹⁸ and R¹⁹ may combine with each other to form a ring.

L² represents a single bond, —O—, —S—, —N(R)— (R is an alkyl group or substitutable aryl group), alkylene group, or arylene group.

A spirofluorene derivative represented by the following formula (4) is also suitable for the host.

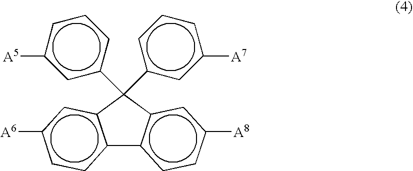

In the above formula (4), each of A⁵ to A⁸ is independently a substituted or unsubstituted biphenyl group or substituted or unsubstituted naphthyl group.

Condensed-ring-containing compound represented by the following formula (5) is also suitable for the host.

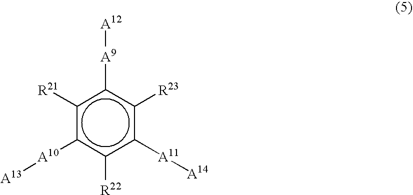

In the above formula (5), each of A⁹ to A¹⁴ represents a hydrogen atom or substituted or unsubstituted aryl group having 6 to 50 ring carbon atoms. Each of R²¹ to R²³ independently represents a hydrogen atom, alkyl group having 1 to 6 carbons, cycloalkyl group having 3 to 6 carbons, alkoxyl group having 1 to 6 carbons, aryloxy group having 5 to 18 carbons, aralkyloxy group having 7 to 18 carbons, arylamino group having 5 to 16 carbons, nitro group, cyano group, ether group having 1 to 6 carbons, or halogen atom. At least one of A⁹ to A¹⁴ is a group having three or more condensed aromatic rings.

A fluorene compound represented by the following formula (6) is also suitable for the host.

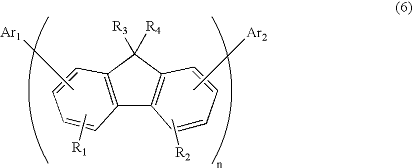

In the above formula (6), R₁ and R₂ represent a hydrogen atom, substituted or unsubstituted alkyl group, substituted or unsubstituted aralkyl group, substituted or unsubstituted aryl group, substituted or unsubstituted heterocyclic group, substituted amino group, cyano group, or halogen atom.

A plurality of R₁ that bond with different fluorene groups may be identical to or different from each other, a plurality of R₂ that bond with different fluorine groups may be identical to or different from each other, and R₁ and R₂ that bond with the same fluorene group may be identical to or different from each other. R₃ and R₄ represent a hydrogen atom, substituted or unsubstituted alkyl group, substituted or unsubstituted aralkyl group, substituted or unsubstituted aryl group, or substituted or unsubstituted heterocyclic ring. A plurality of R₃ that bond with different fluorene groups may be identical to or different from each other, a plurality of R₄ that bond with different fluorene groups may be identical to or different from each other, and R₃ and R₄ that bond with the same fluorene group may be identical to or different from each other. Ar₁ and Ar₂ represent a substituted or unsubstituted condensed polycyclic aromatic group that has three or more benzene rings or condensed polycyclic heterocyclic group that has a total of three or more benzene rings and heterocyclic rings and bonds with fluorene group by substituted or unsubstituted carbons. Ar₁ and Ar₂ may be identical to or different from each other. The sign n refers to an integer from 1 to 10.

Of the above host materials, anthracene derivative is preferable, monoanthracene derivative is further preferable, and asymmetric anthracene, in which left and right sides of anthracene skeleton are different from each other, is especially preferable.

A naphthacene derivative represented by the following formula (7) is also suitable for the host.

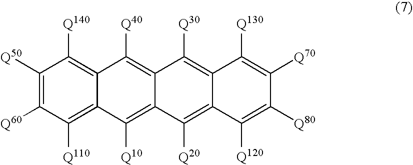

In the above formula (7), each of Q¹⁰, Q²⁰, Q³⁰, Q⁴⁰, Q⁵⁰, Q⁶⁰, Q⁷⁰, Q⁸⁰, Q¹¹⁰, Q¹²⁰, Q¹³⁰, and Q¹⁴⁰ represents a hydrogen, alkyl group having 1 to 20 carbons, aryl group having 1 to 20 carbons, amino group, alkoxy group having 1 to 20 carbons, alkylthio group having 1 to 20 carbons, aryloxy group having 1 to 20 carbons, arylthio group having 1 to 20 carbons, alkenyl group having 1 to 20 carbons, aralkyl group having 1 to 20 carbons, or heterocyclic group, and may be identical to or different from each other.

One or more of Q¹⁰, Q²⁰, Q³⁰ and Q⁴⁰ in the naphthacene derivative represented by the above formula (7) may preferably be an aryl group, and may further preferably be represented by the following formula (8).

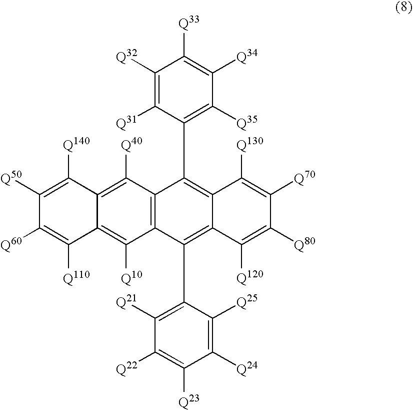

In the above formula (8), each of Q¹⁰, Q²¹ to Q²⁵, Q³¹ to Q³⁵, Q⁴⁰ to Q⁸⁰, and Q¹¹⁰ to Q¹⁴⁰ may be a hydrogen, alkyl group, aryl group, amino group, alkoxy group, aryloxy group, alkylthio group, arylthio group, alkenyl group, aralkyl group, and heterocyclic group, and may be identical to or different from each other.

Adjacent two or more of Q²¹ to Q²⁵ and Q³¹ to Q³⁵ may bond with each other to form a ring.

One or more of Q²¹, Q²⁵, Q³¹, and Q³⁵ in the naphthacene derivative may preferably be an alkyl group, aryl group, amino group, alkoxy group, alkylthio group, aryloxy group, arylthio group, alkenyl group, aralkyl group, and heterocyclic group.

A fluoranthene derivative represented by the following formula (9) is also suitable for the host.

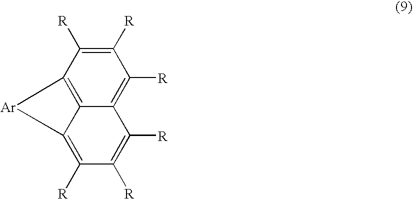

In the above formula (9), Ar represents a substituted or unsubstituted aromatic group having 6 to 50 ring carbon atoms. The plurality of R may be different from each other, and each of the plurality of R independently is a hydrogen atom, substituted or unsubstituted aromatic group having 6 to 50 ring carbon atoms, substituted or unsubstituted aromatic heterocyclic group having 5 to 50 ring atoms, or substituted or unsubstituted alkyl group having 1 to 50 carbons.

The following are specific examples of the above fluoranthene derivative.

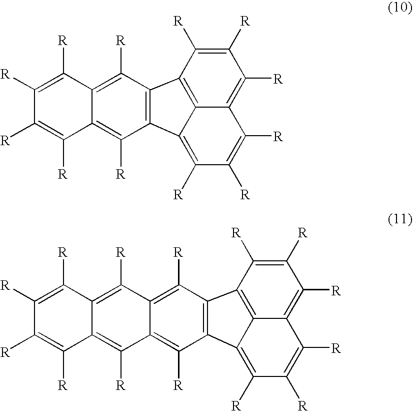

R in the above formulae (10) and (11) is the same as R in the above formula (9).

It is preferable that R be a hydrogen or phenyl group.

It is further preferable that two of R which substitute on opposing sides of a naphthalene skeleton or anthracene skeleton be a phenyl group and the rest of R be a hydrogen.

Next, a material already known to possess a long life and light emitting property can be used for the first dopant and the second dopant.

Concentrations of such a first dopant and such a second dopant are determined so that luminous intensity I₁ of the first dopant is twelve times as great as that of the second dopant or greater and the content of the second dopant is 0.001% to 0.5% by mass.

In this case, the one with smaller energy gap is selected as the second dopant so that the second dopant serves as an electric charge trap.

Further, in view of providing a blue emitting material having a longer lifetime, it is preferable that a material in which Eg≧2.9 eV be selected as the first dopant and the second dopant be added to extend the life of the blue material (i.e. the first dopant).

Dopant materials suitable for combining with the host materials described above will be listed below, from which the first dopant and second dopant are appropriately selected.

An amine dopant represented by the following formula is suitable for the dopant.

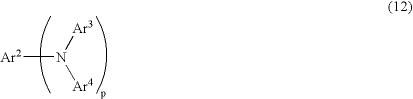

In the above formula (12), Ar² to Ar⁴ are a substituted or unsubstituted aromatic group having 6 to 50 ring carbon atoms or substituted or unsubstituted styryl group.

The sign p refers to an integer from 1 to 4.

If p≧2, each of Ar³ may be identical to or different from each other, and each of Ar⁴ may be identical to or different from each other.

Examples of the substituted or unsubstituted aromatic group having 6 to 50 ring carbon atoms include a phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl-group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, 4″-t-butyl-p-terphenyl-4-yl group, 2-fluorenyl group, 9,9-dimethyl-2-fluorenyl group, 3-fluoranthenyl group, and the like.

A phenyl group, 1-naphthyl group, 2-naphthyl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, o-tolyl group, m-tolyl group, p-tolyl group, p-t-butylphenyl group, 2-fluorenyl group, 9,9-dimethyl-2-fluorenyl group, 3-fluoranthenyl group, or the like is preferable.

Examples of the substituted or unsubstituted styryl group include a 2-phenyl-1-vinyl group, 2,2-diphenyl-1-vinyl group, 1,2,2-triphenyl-1-vinyl group, and the like.

Specific examples of the general formula (12) and examples of other compounds suitable for the dopant will be shown below.

Note that in the formula, Me represents a methyl group and Et represents an ethyl group.

The substituted styryl group is not limited to one in which the styryl group and N are directly bonded, but also includes one in which a divalent group (e.g. an arylene group, typically a phenylene group, or the like) are provided between the styryl group and N.

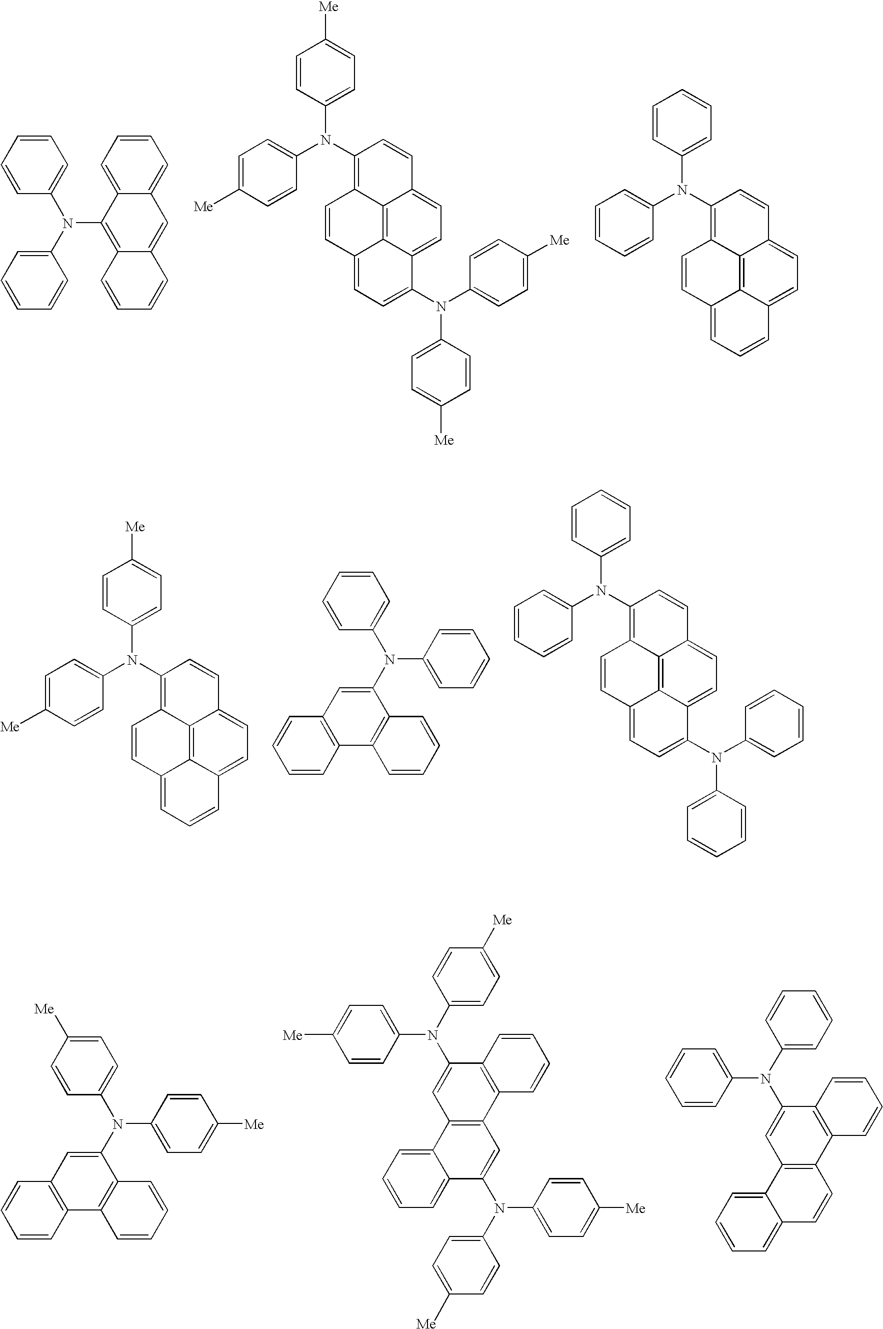

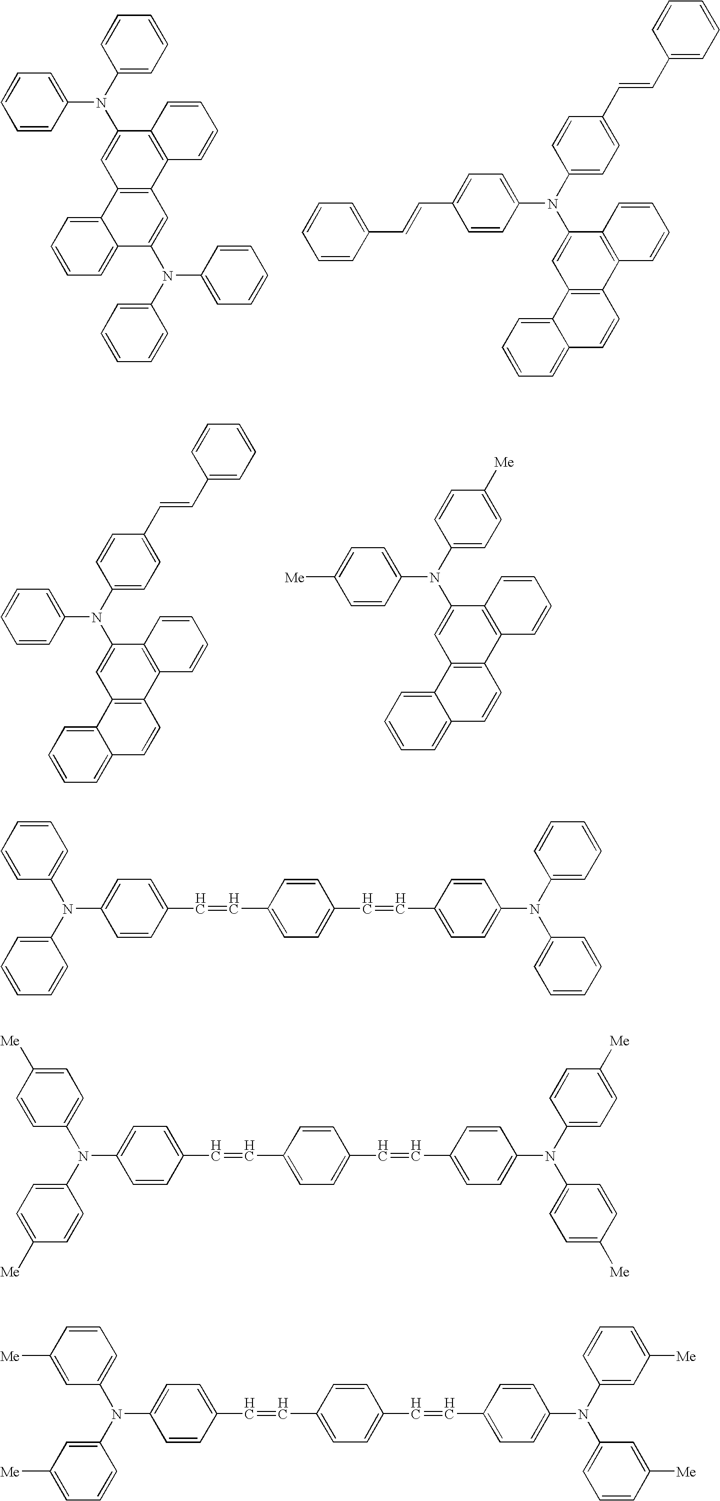

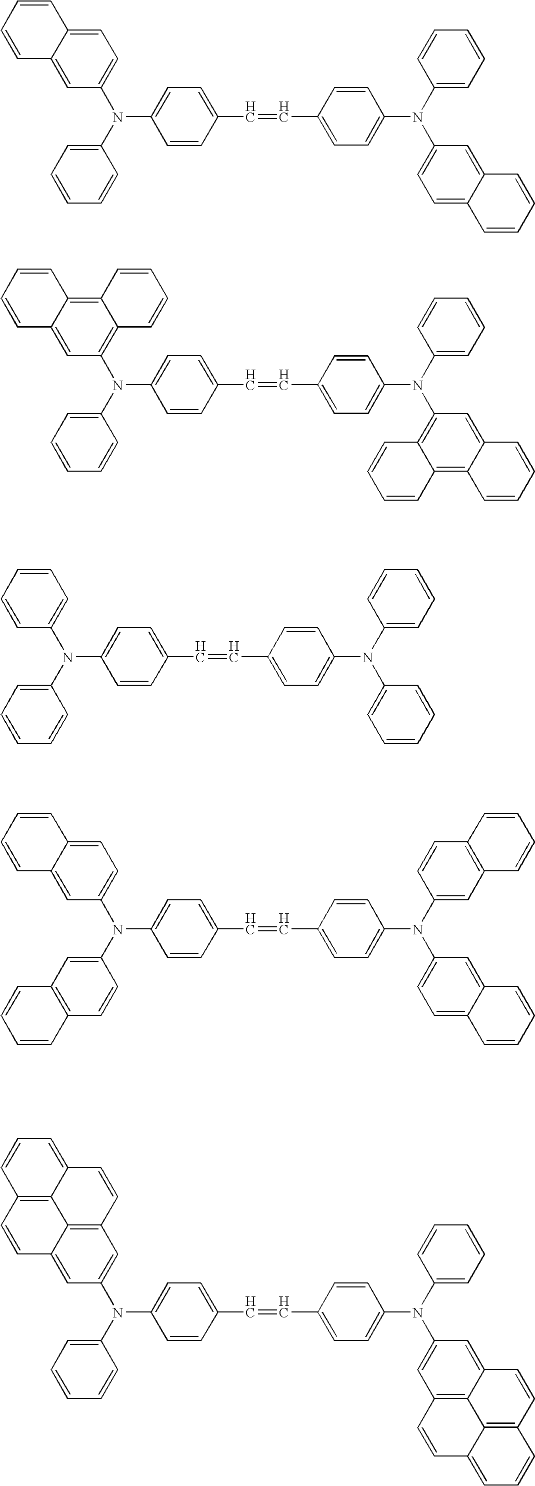

The following is capable for use as the first dopant, but rather suitable for use as the second dopant.

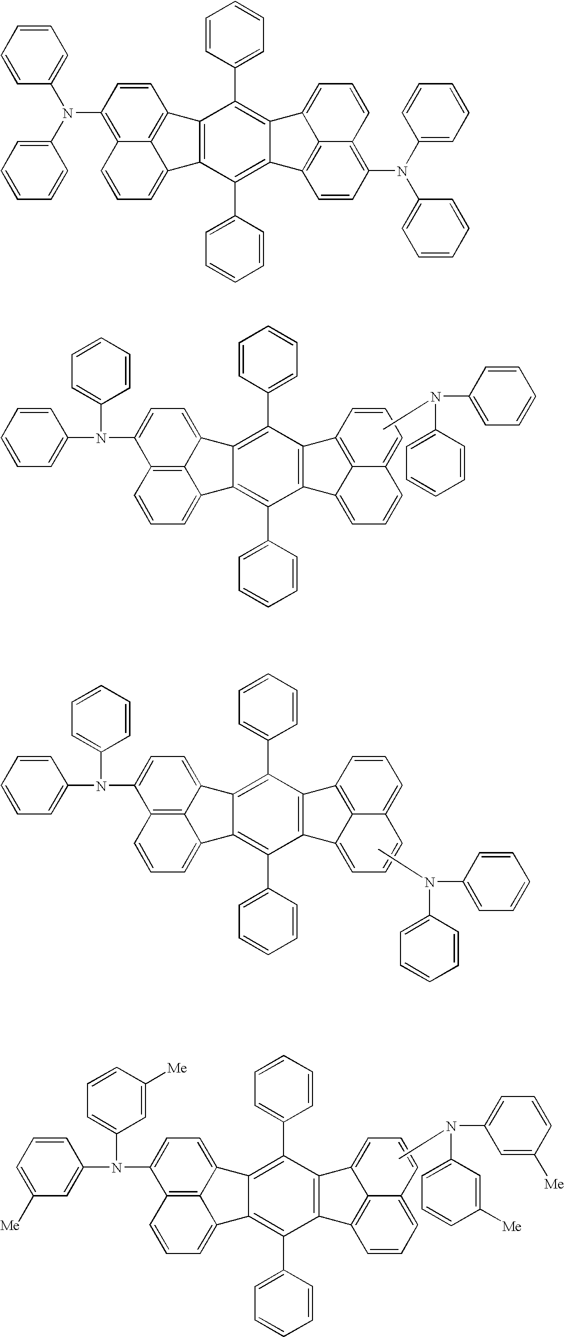

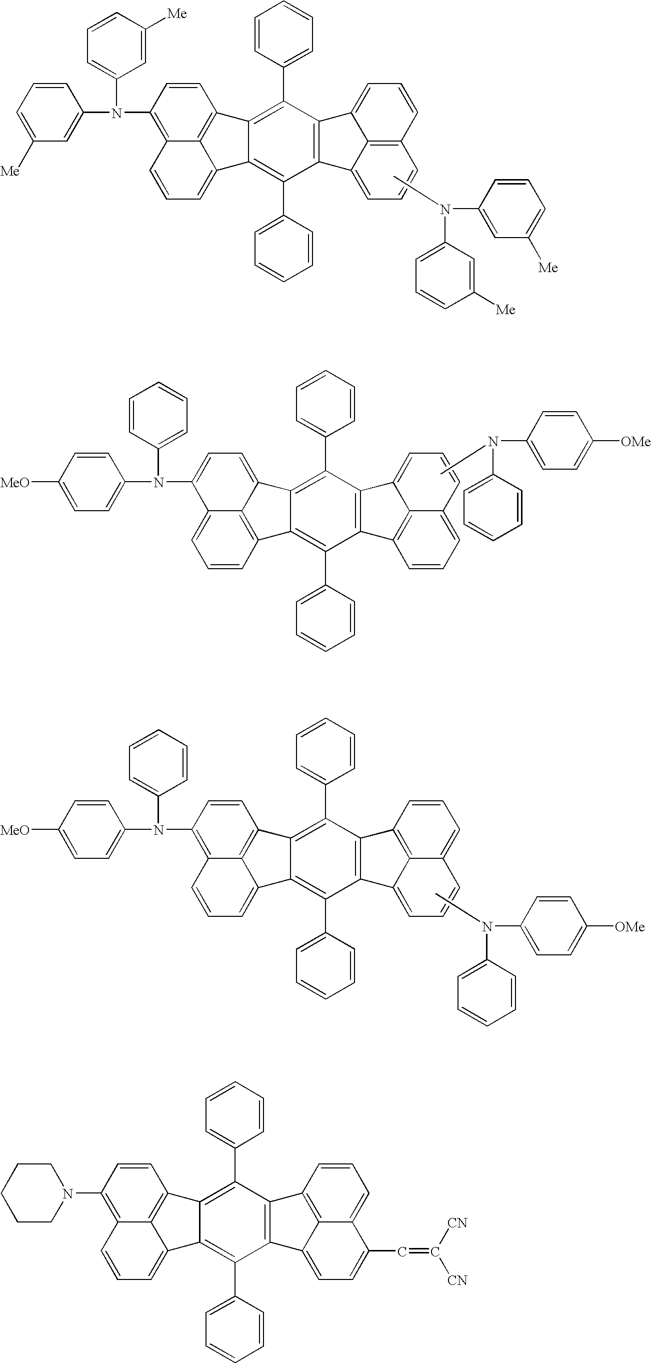

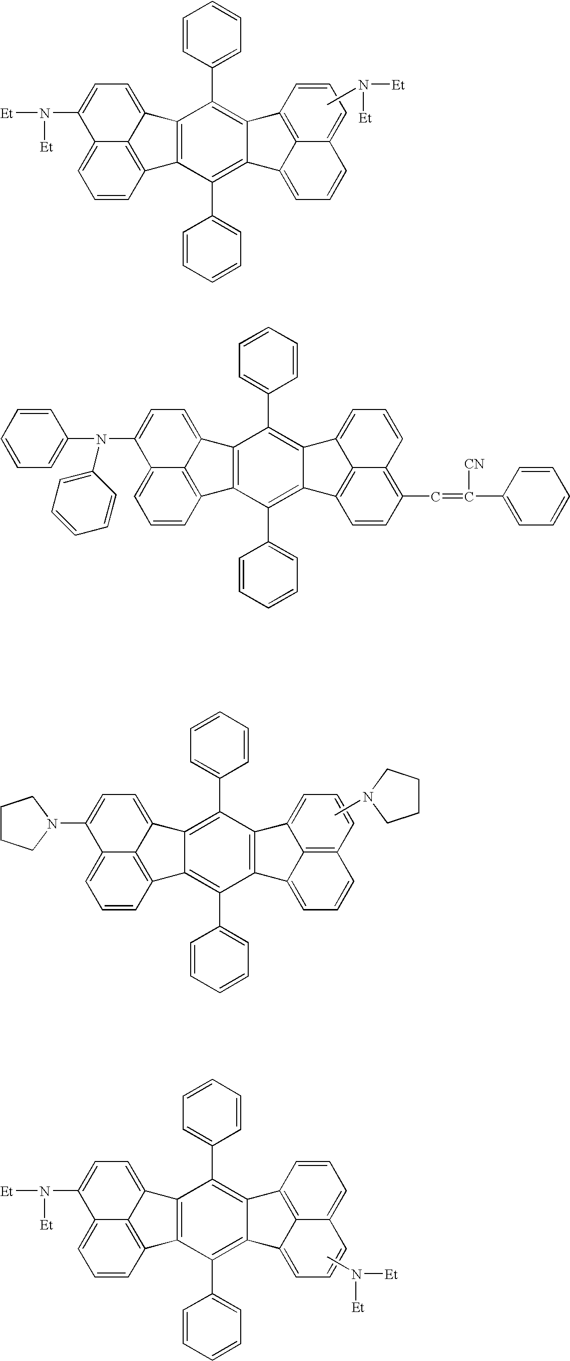

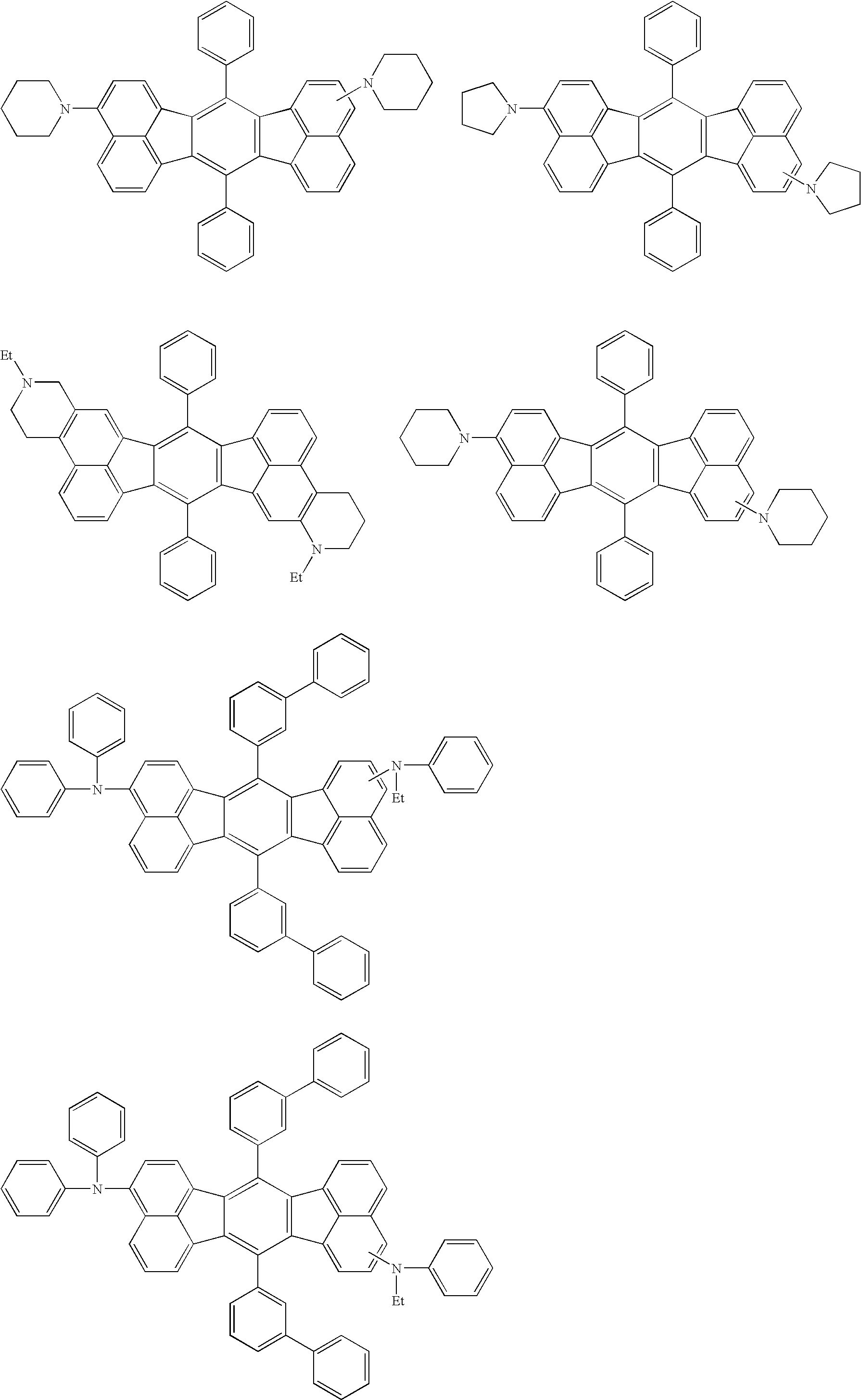

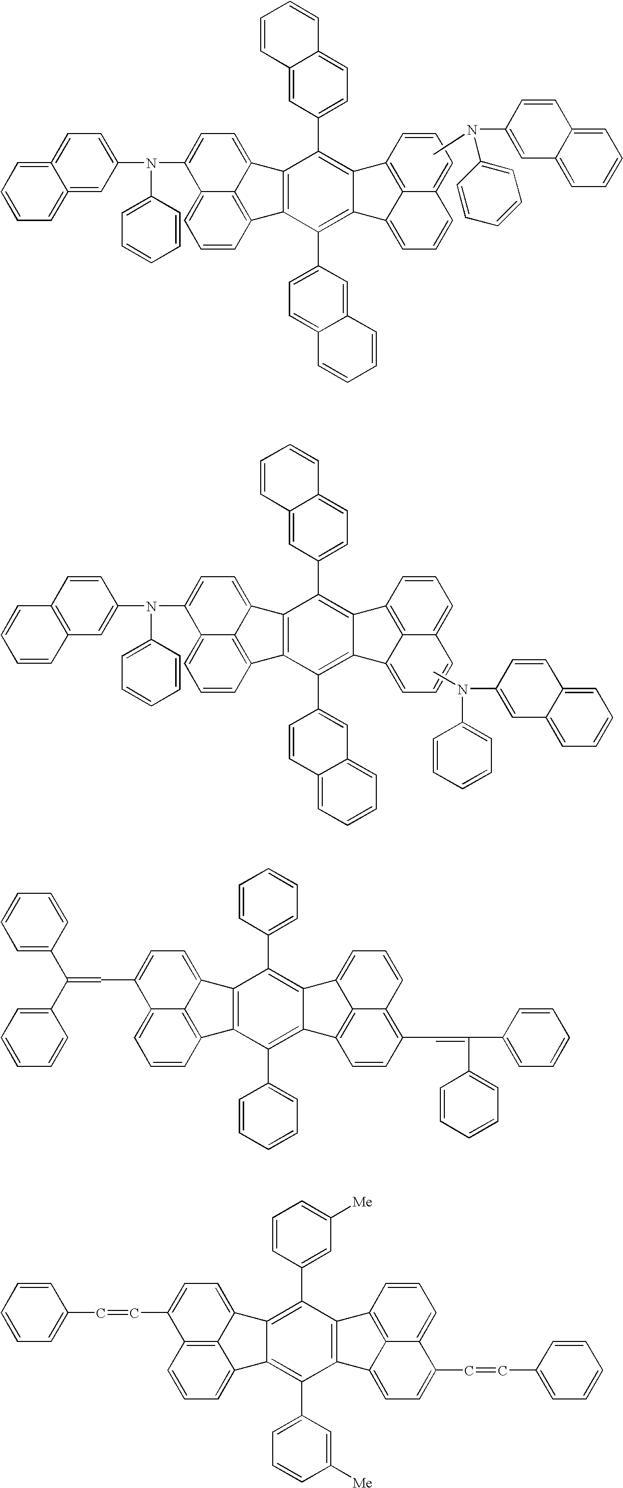

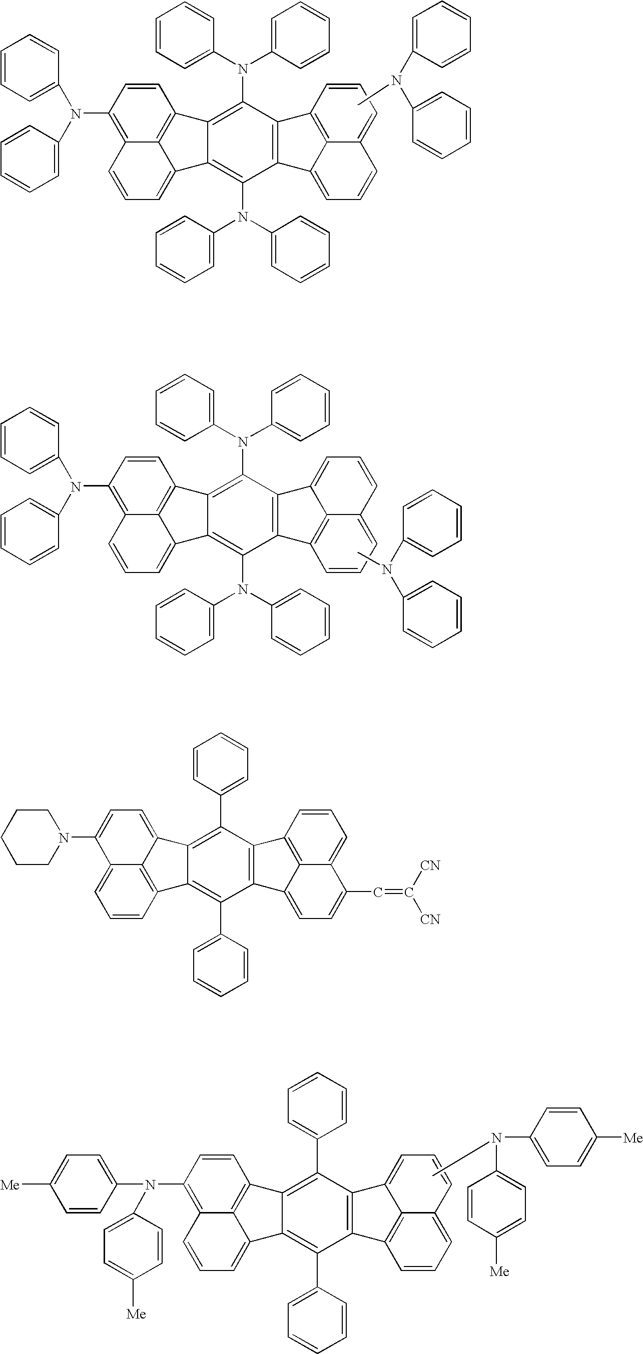

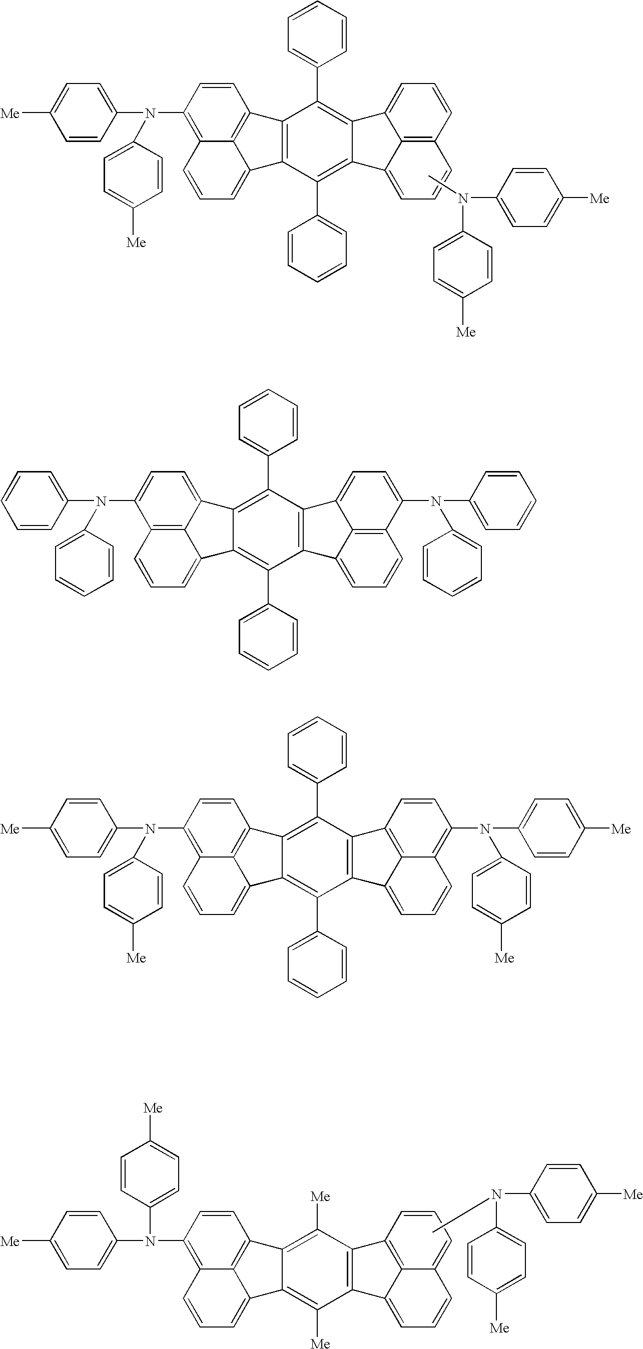

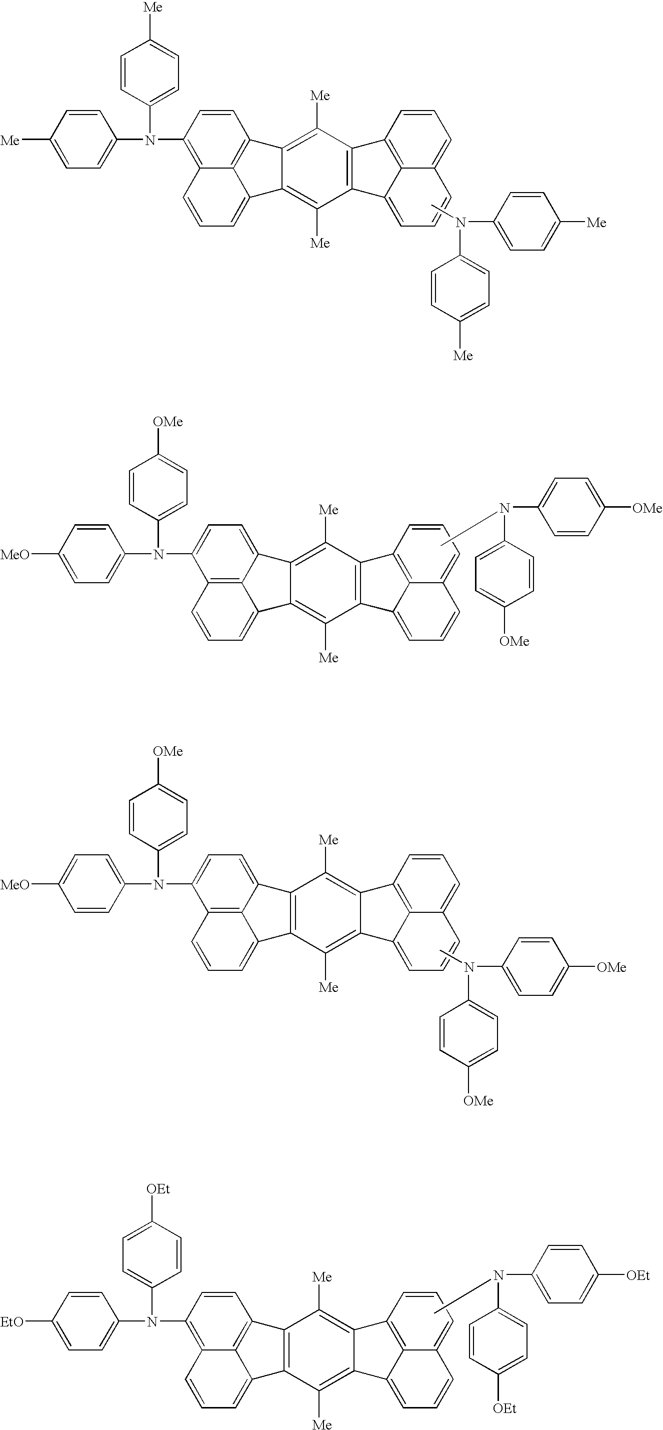

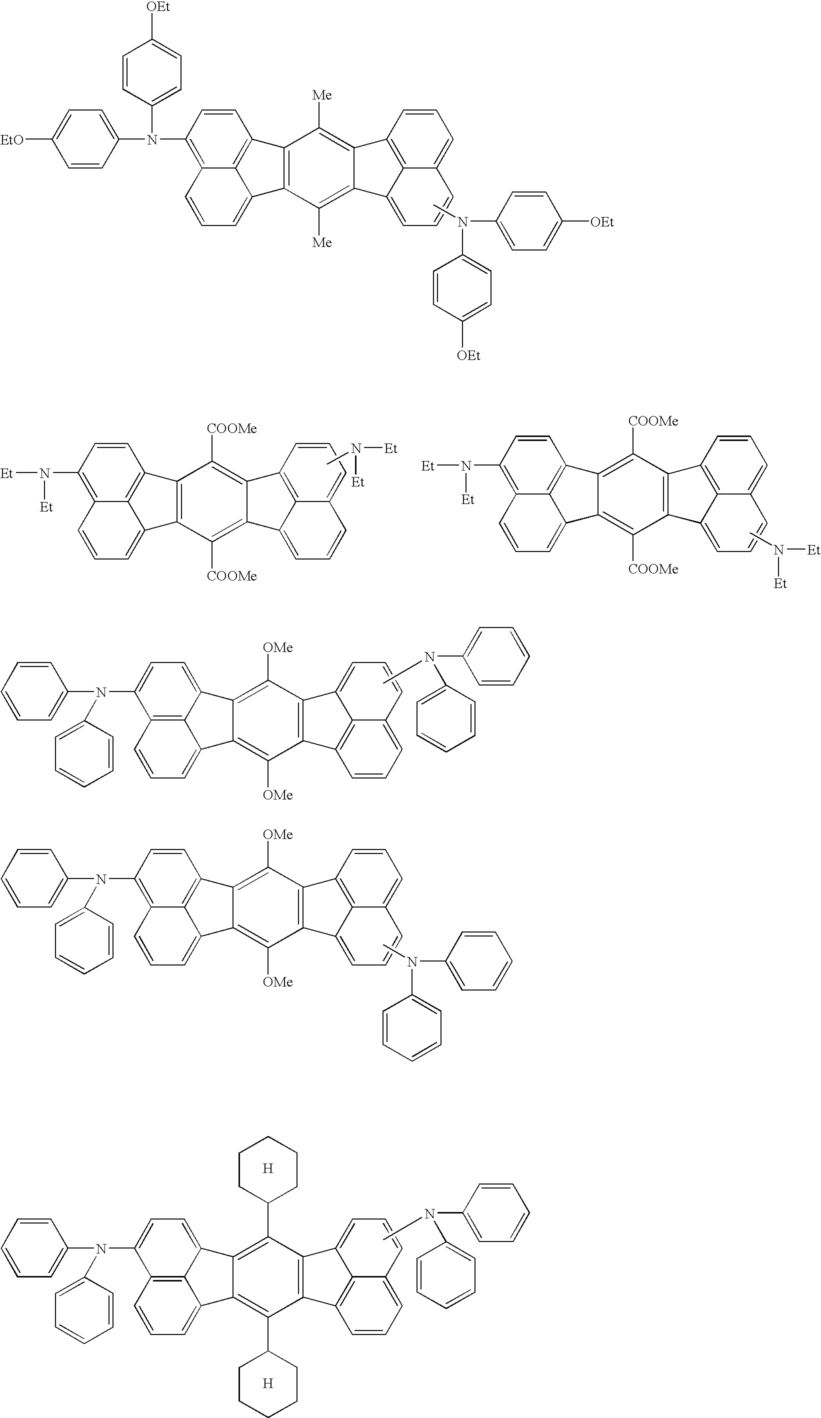

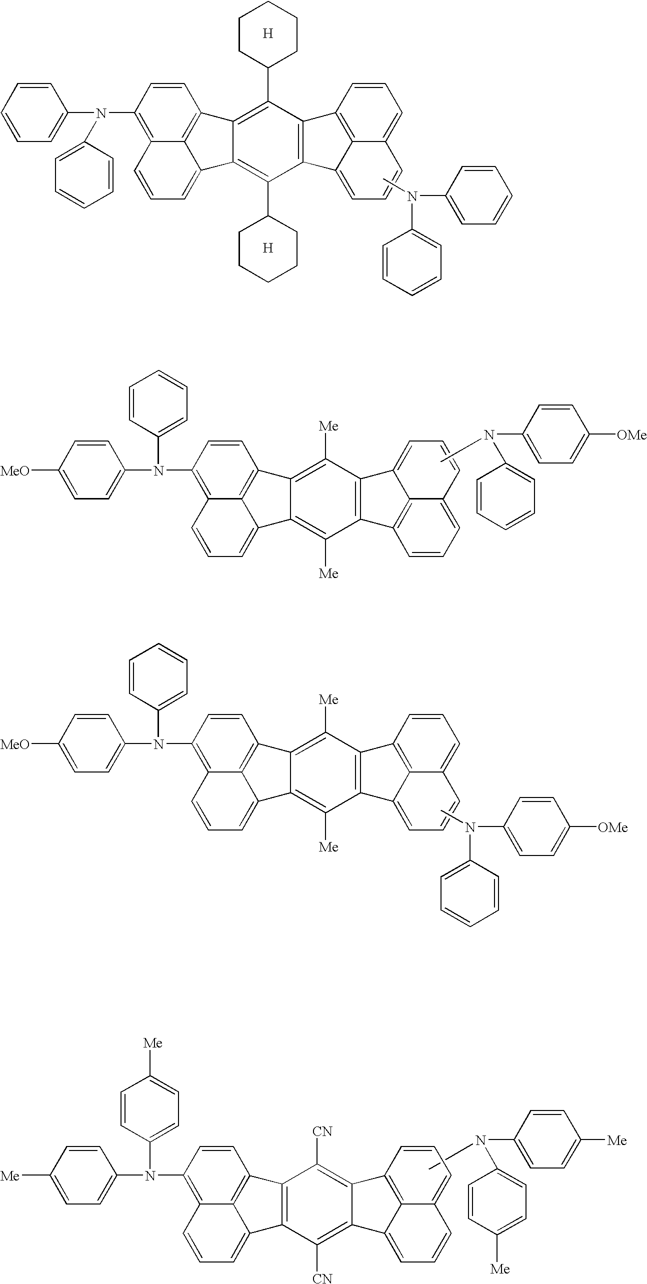

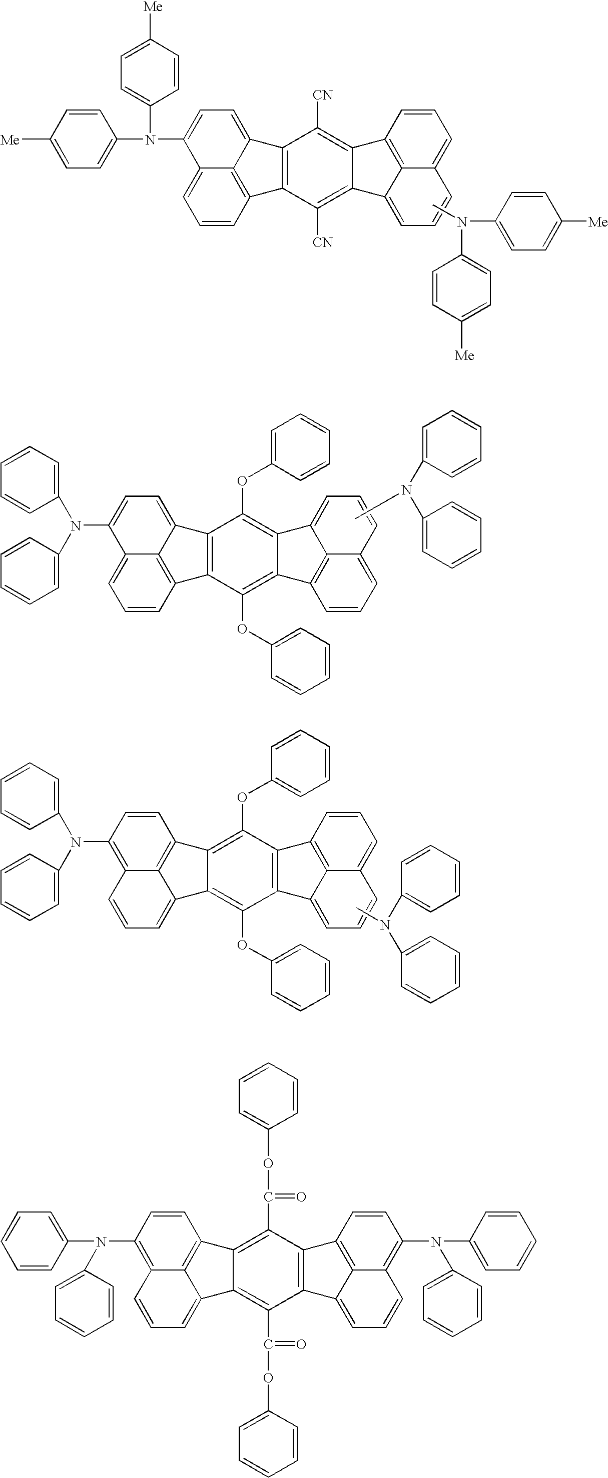

Perylene derivatives of the following formulae (13) and (14) are suitable for the second dopant, and especially suitable for combining with the host of the above-described naphthacene derivative.

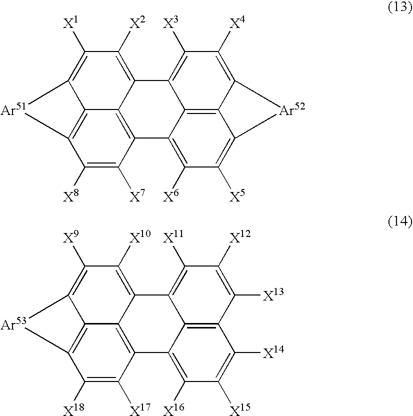

In the above general formulae (13) and (14), each of Ar⁵¹, Ar⁵², and Ar⁵³ independently represents a substituted or unsubstituted aromatic hydrocarbon group having 6 to 50 ring carbon atoms or substituted or unsubstituted aromatic heterocylic group having 6 to 50 ring atoms.

Each of X¹ to X¹⁸ independently represents a group selected from a hydrogen atom, halogen atom, substituted or unsubstituted alkyl group having 1 to 50 carbons, substituted or unsubstituted alkoxy group having 1 to 50 carbons, substituted or unsubstituted alkylthio group having 1 to 50 carbons, substituted or unsubstituted alkenyl group having 2 to 50 carbons, substituted or unsubstituted alkenyloxy group having 1 to 50 carbons, substituted or unsubstituted alkenylthio group having 1 to 50 carbons, substituted or unsubstituted aromatic hydrocarbon group having 6 to 50 ring carbon atoms, substituted or unsubstituted aromatic heterocyclic group having 6 to 50 ring atoms, substituted or unsubstituted aryloxy group having 6 to 50 ring carbon atoms, substituted or unsubstituted arylthio group having 6 to 50 ring carbon atoms, substituted or unsubstituted aralkyl group having 7 to 50 ring carbon atoms, substituted or unsubstituted arylalkyloxy group having 6 to 50 ring carbon atoms, substituted or unsubstituted arylalkylthio group having 6 to 50 ring carbon atoms, substituted or unsubstituted arylalkenyl group having 6 to 50 ring carbon atoms, substituted or unsubstituted alkenylaryl group having 6 to 50 ring carbon atoms, amino group, carbazolyl group, cyano group, hydroxyl group, —COOR⁵⁴, —COR⁵⁵, or —OCOR⁵⁶ (in which each of R⁵⁴, R⁵⁵, or R⁵⁶ represents a hydrogen atom, substituted or unsubstituted alkyl group having 1 to 50 carbons, substituted or unsubstituted alkenyl group having 2 to 50 carbons, substituted or unsubstituted aralkyl group having 7 to 50 ring carbon atoms, substituted or unsubstituted aromatic hydrocarbon group having 6 to 50 ring carbon atoms, and aromatic heterocyclic group having 6 to 50 ring atoms).

Adjacent groups may bond with each other, and further may form a ring together with carbon atoms to which X¹ to X¹⁸ are bonded.

Here, in the above formulae (13) and (14), it is preferable that at least one of X¹ to X¹⁸ not be hydrogen or at least one of the substituent groups Ar⁵¹, Ar⁵², and Ar⁵³, X¹ to X¹⁸, and the substituent groups of X¹ to X¹⁸ be a halogen atom.

Of the perylene derivatives, an indenoperylene derivative will be shown below.

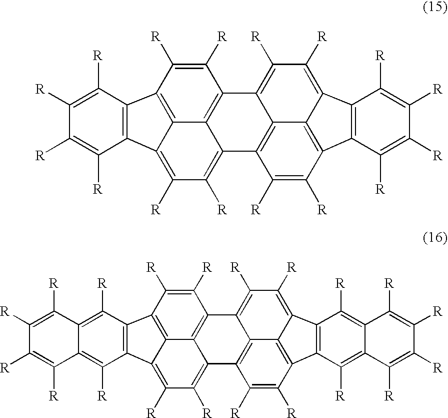

In the above formulae (15) and (16), each of R, which may be different from each other, independently is a hydrogen atom, halogen atom, alkyl group, alkoxy group, alkylthio group, alkenyl group, alkenyloxy group, alkenylthio group, aromatic-ring-containing alkyl group, aromatic-ring-containing alkyloxy group, aromatic-ring-containing alkylthio group, aromatic ring group, aromatic ring heterocyclic group, aromatic ring oxy group, aromatic ring thio group, aromatic ring alkenyl group, alkenyl aromatic ring group, amino group, carbazolyl group, cyano group, hydroxyl group, —COOR⁵¹ (in which R⁵¹ is hydrogen, alkyl group, alkenyl group, aromatic-ring-containing alkyl group, or aromatic ring group), —COR⁵² (R⁵² is a hydrogen, alkyl group, alkenyl group, aromatic-ring-containing alkyl group, aromatic ring group, or amino group), or —OCOR⁵³ (R⁵³ is an alkyl group, alkenyl group, aromatic-ring-containing alkyl group, or aromatic ring group).

Here, groups adjacent to R may bond with each other, or may form a ring together with substituted carbon atoms.

Further, it is preferable that at least one of R not be hydrogen.

Other than the ones described above, the dopant may be, but is not limited to, a naphthalene derivative, anthracene derivative, perylene derivative, pyrene derivative, naphthacene derivative, rubrene derivative, fluoranthene derivative, benzofluoranthene derivative, diindenoperylene derivative, styrylamine derivative, bisamino-distilbene derivative, acridone derivative, acridine derivative, quinacridone derivative, coumalin derivative (e.g. coumalin 1, coumalin 6, coumalin 7, coumalin 30, coumalin 106, coumalin 138, coumalin 151, coumalin 152, coumalin 153, coumalin 307, coumalin 311, coumalin 314, coumalin 334, coumalin 338, coumalin 343, coumalin 500), pyrane derivative (e.g. DCM1, DCM2), oxazone derivative (e.g. Nile Red), arylamine compound and/or styrylamine compound, coronene, chrysene, fluoresceine, phthaloperylene, naphthaloperylene, perynone, phthaloperynone, naphthaloperynone, diphenylbutadiene, tetraphenylbutadiene, oxadiazole, aldazine, bisbenzoxazoline, bisstyryl, pyrazine, cyclopentadiene, metal complex of quinoline, metal complex of aminoquinolin, metal complex of benzoquinoline, imine, diphenylethylene, vinylanthracene, diaminocarbazole, pyrane, thiopyrane, polymethine, merocyanine, chelate of oxinoid compound with imidazole, fluorescent pigment, or the like.

The electron transporting zone 133 will be described next.

The electron transporting zone 133 includes an electron transporting layer 133A and an electron injecting layer 133B.

The electron transporting layer 133A, which facilitates injection of an electron to the emitting layer 132, has high electron mobility.

In the embodiment, in order to lower drive voltage, the electron transporting layer 133A preferably possesses high electron mobility, namely, electron mobility of 10⁻⁴ cm²/Vs or more in the case of applying an electric field of 0.25 mV/cm.

If the electron transporting layer 133A having high electron mobility as have mentioned is employed, the drive voltage is decreased. On the other hand, excessive injection of electrons into the emitting layer 132 may shorten lifetime.

In the embodiment, with regard to the problem, the second dopant is doped to the emitting layer 132 so that the second dopant serves as an electron trap, thus providing electric charge balance in the embodiment.

Therefore, the electron transporting layer 133A having high electron mobility is provided to achieve low drive voltage and a long lifetime at the same time.

Also, it is known that light emission acquired directly from the anode 12 and light emission acquired via reflection to the electrode interfere with each other in a bottom emission type OELD like the one in the embodiment.

In order to take advantage of this interference effect, the electron transporting layer 133A is appropriately adjusted between several nm to several μm.

In this case, thickening of the electron transporting layer 133A may cause increase in the voltage etc. However, since the electron transporting layer 133A having high electron mobility is provided in the embodiment, thickening the layer to an extent where the interfering effect can fully be made use of does not necessarily lead to increase in the drive voltage.

Specific compounds for the electron transporting layer 133A is exemplified by a nitrogen-containing heterocyclic derivative represented by the above formula (1), and specific examples of the nitrogen-containing heterocyclic derivative include the following. Note that materials for the electron transporting layer of the present invention are not limited to the following compounds, which are shown as examples.

HAr—L—Ar¹—Ar²

| | HAr | L | Ar¹ | Ar² |
|---|---|---|---|---|
| 1-1 | 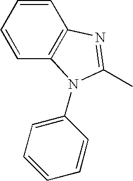 | 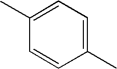 | 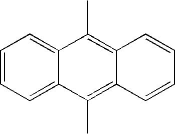 | 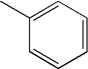 |
| 2 | 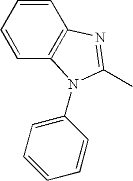 | 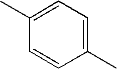 | 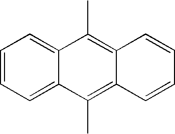 | 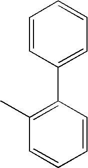 |
| 3 | 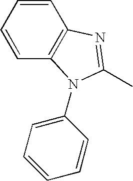 | 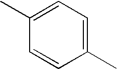 | 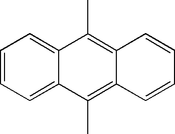 | 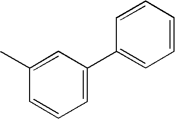 |
| 4 | 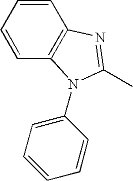 | 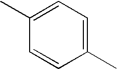 | 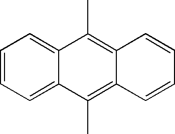 | 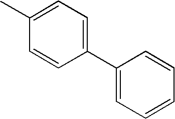 |
| 5 | 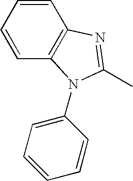 | 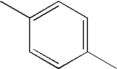 | 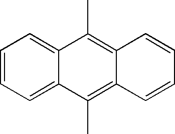 | 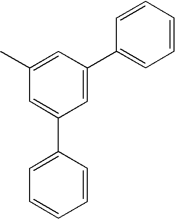 |
| 6 | 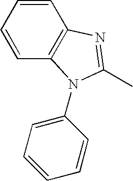 | 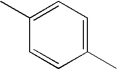 | 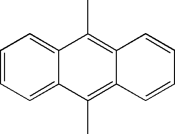 | 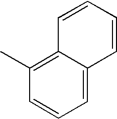 |
| 7 | 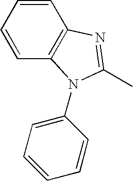 | 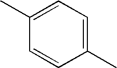 | 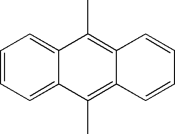 | 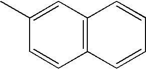 |
| 8 | 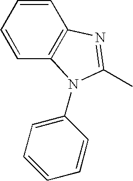 | 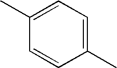 | 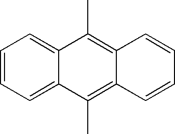 | 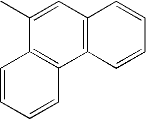 |
| 9 | 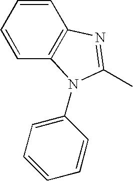 | 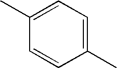 | 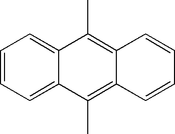 | 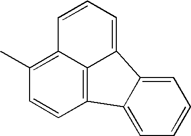 |
| 10 | 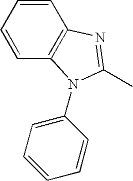 | 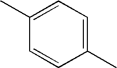 | 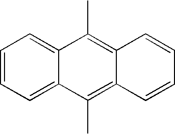 | 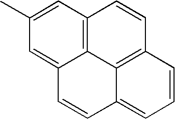 |
| 11 | 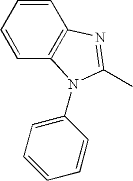 | 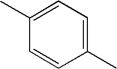 | 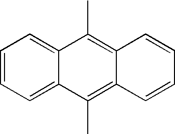 | 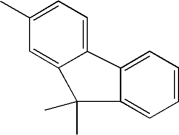 |
| 12 | 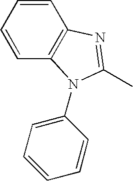 | 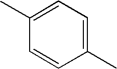 | 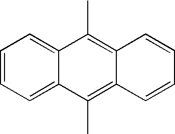 | 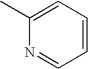 |
| 13 | 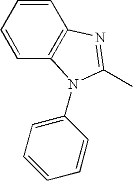 | 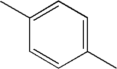 | 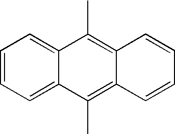 | 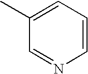 |
| 14 | 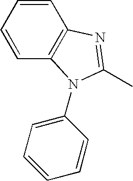 | 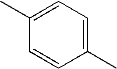 | 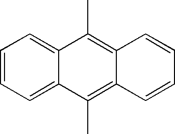 | 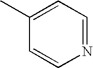 |
| 2-1 | 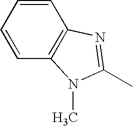 | 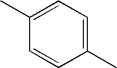 | 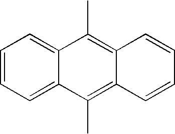 | 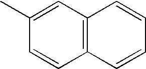 |
| 2 | 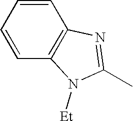 | 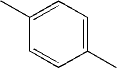 | 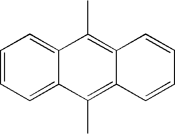 | 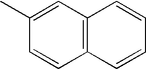 |
| 3 | 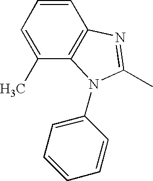 | 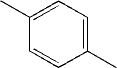 | 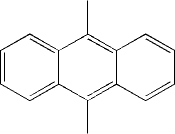 | 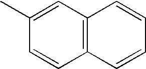 |
| 4 | 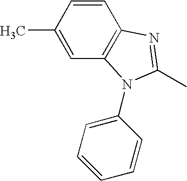 | 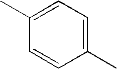 | 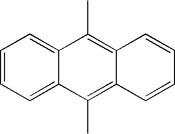 | 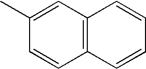 |
| 5 | 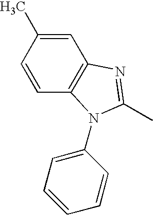 | 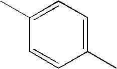 | 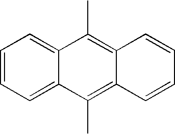 | 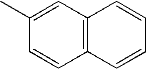 |
| 6 | 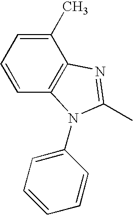 | 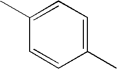 | 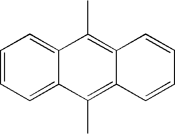 | 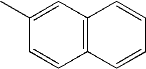 |
| 7 | 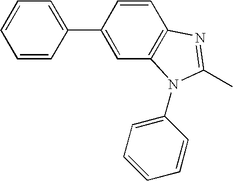 | 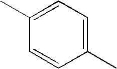 | 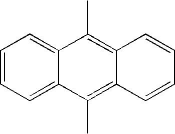 | 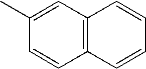 |
| 8 | 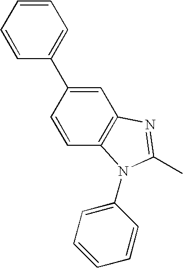 | 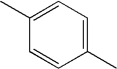 | 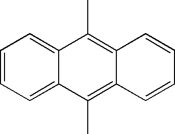 | 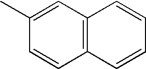 |
| 9 | 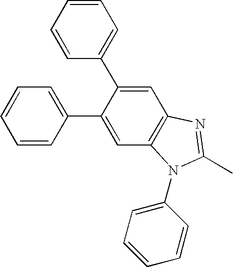 | 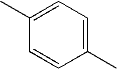 | 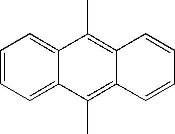 | 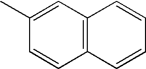 |
| 3-1 | 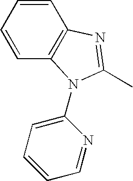 | 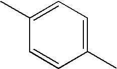 | 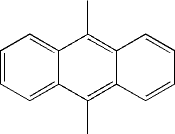 | 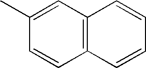 |
| 2 | 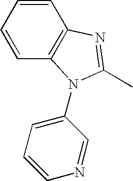 | 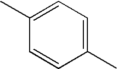 | 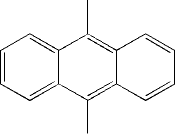 | 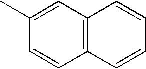 |
| 3 | 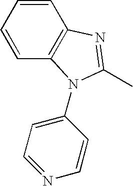 | 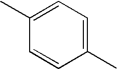 | 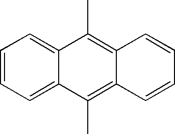 | 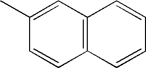 |
| 4 | 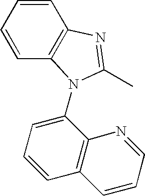 | 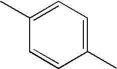 | 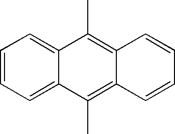 | 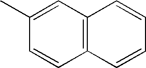 |
| 5 | 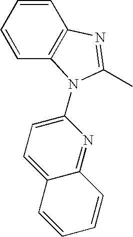 | 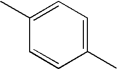 | 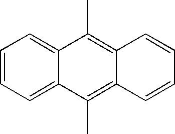 | 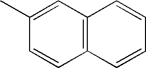 |
| 6 | 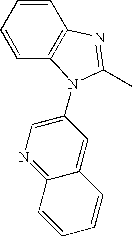 | 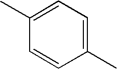 | 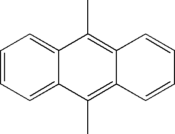 | 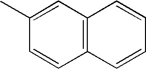 |
| 4-1 | 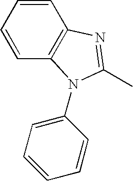 | 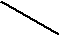 | 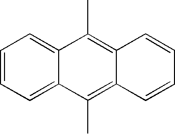 | 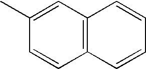 |
| 2 | 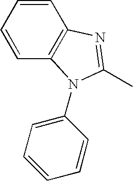 | 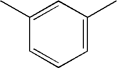 | 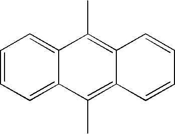 | 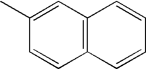 |
| 3 | 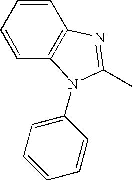 | 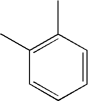 | 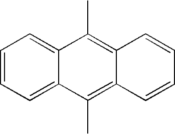 | 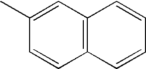 |
| 4 | 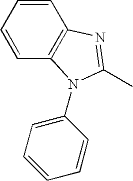 | 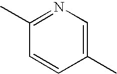 | 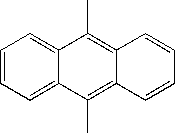 | 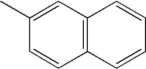 |
| 5 | 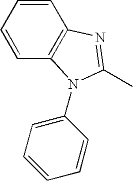 | 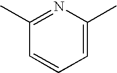 | 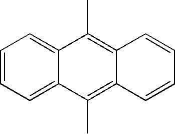 | 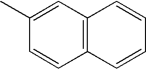 |
| 6 | 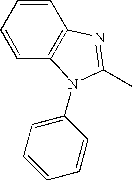 | 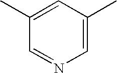 | 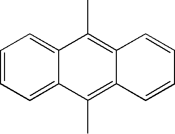 | 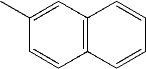 |
| 7 | 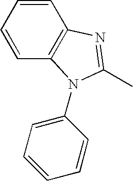 | 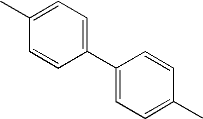 | 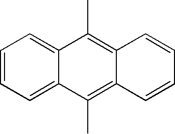 | 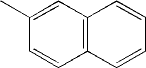 |
| 8 | 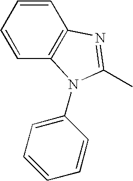 | 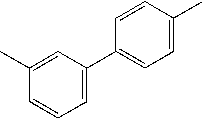 | 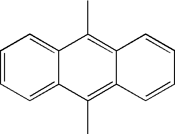 | 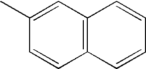 |
| 9 | 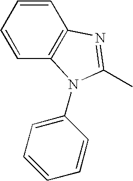 | 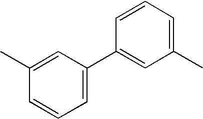 | 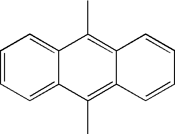 | 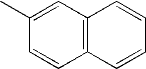 |
| 10 | 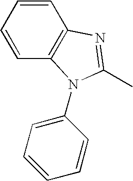 | 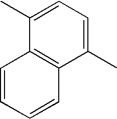 | 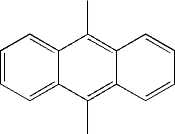 | 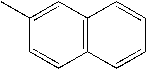 |
| 11 | 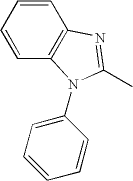 | 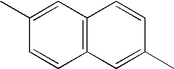 | 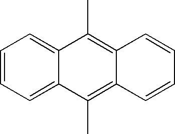 | 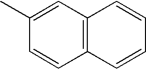 |
| 12 | 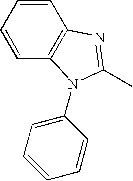 | 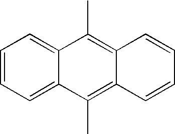 | 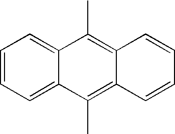 | 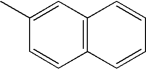 |
| 5-1 | 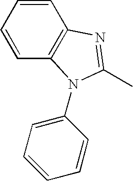 | 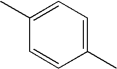 | 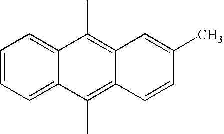 | 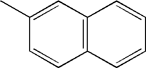 |
| 2 | 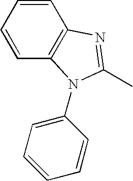 | 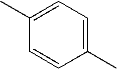 | 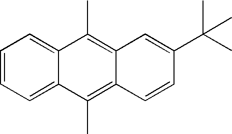 | 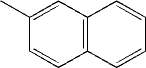 |
| 3 | 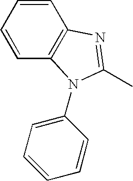 | 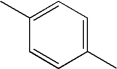 | 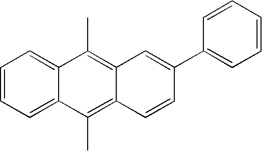 | 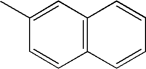 |
| 4 | 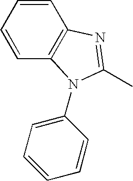 | 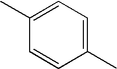 | 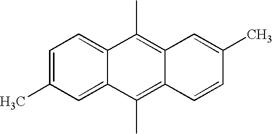 | 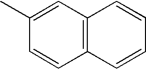 |
| 5 | 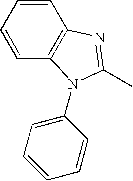 | 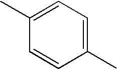 | 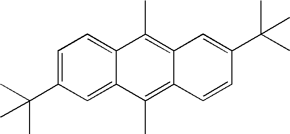 | 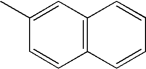 |
| 6 | 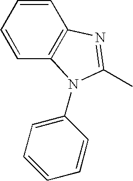 | 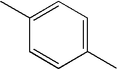 | 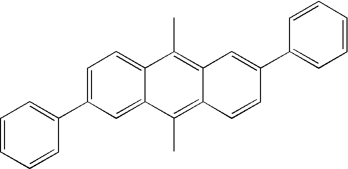 | 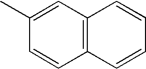 |
| 6-1 | 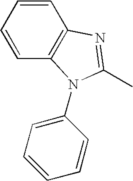 | 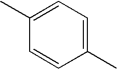 | 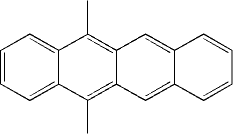 | 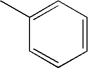 |
| 2 | 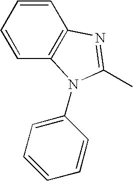 | 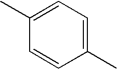 | 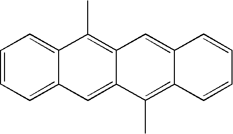 | 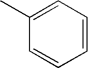 |
| 3 | 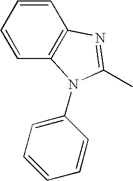 | 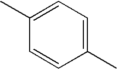 | 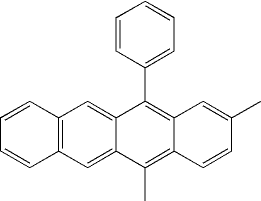 | 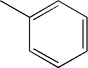 |
| 4 | 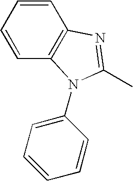 | 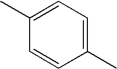 | 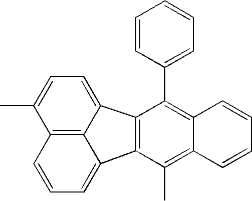 | 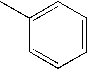 |
| 5 | 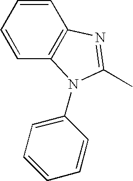 | 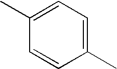 | 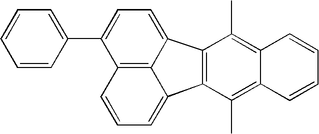 | 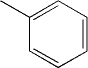 |
| 7-1 | 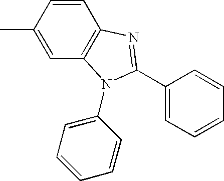 | 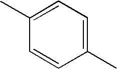 | 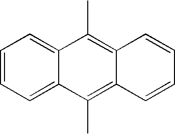 | 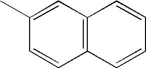 |
| 2 | 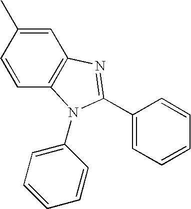 | 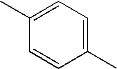 | 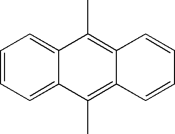 | 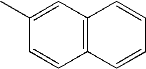 |
| 3 | 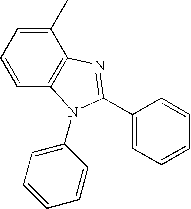 | 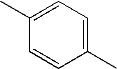 | 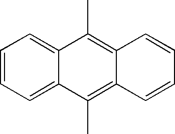 | 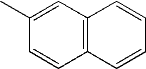 |
| 4 | 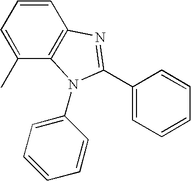 | 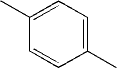 | 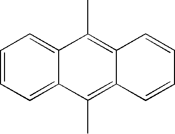 | 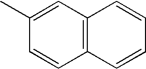 |
| 5 | 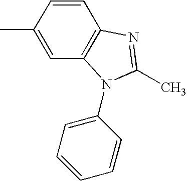 | 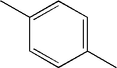 | 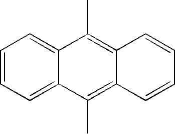 | 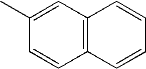 |
| 6 | 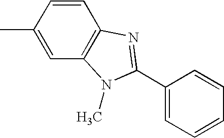 | 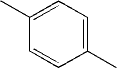 | 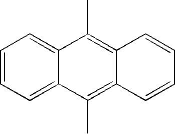 | 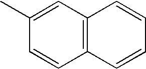 |
| 7 | 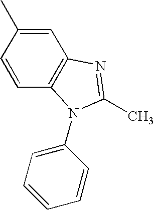 | 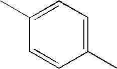 | 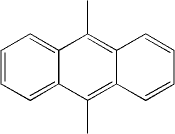 | 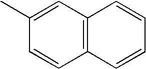 |
| 8 | 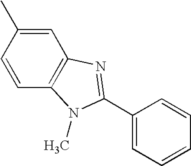 | 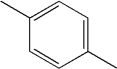 | 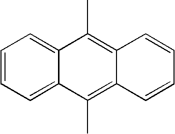 | 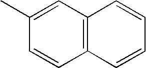 |
| 9 | 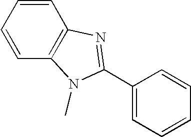 | 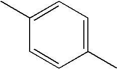 | 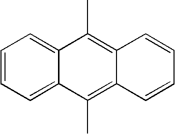 | 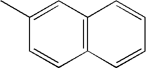 |
| 10 | 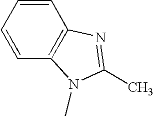 | 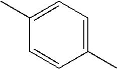 | 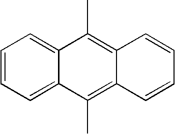 | 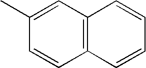 |
| 8-1 | 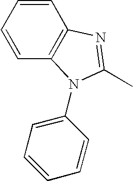 | 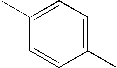 | 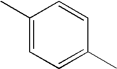 | 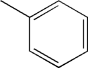 |
| 2 | 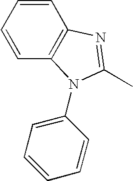 | 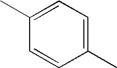 | 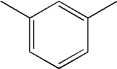 | 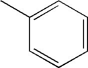 |
| 3 | 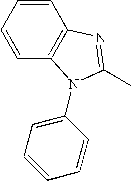 | 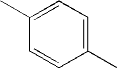 | 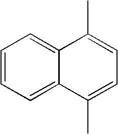 | 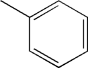 |
| 4 | 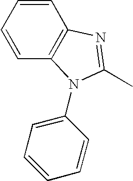 | 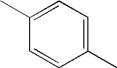 | 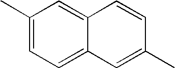 | 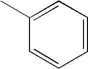 |
| 5 | 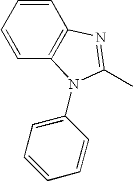 | 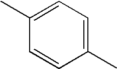 | 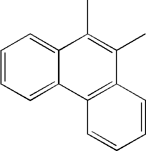 | 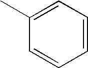 |
| 6 | 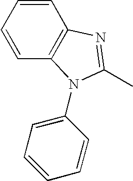 | 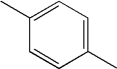 | 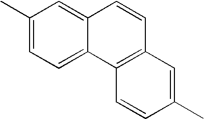 | 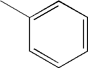 |
| 7 | 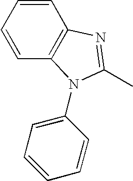 | 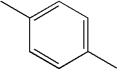 | 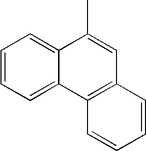 | 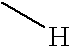 |
| 8 | 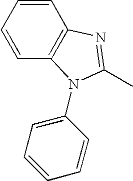 | 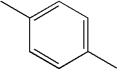 | 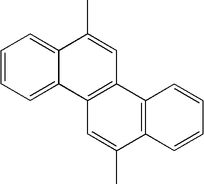 | 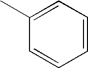 |
| 9 | 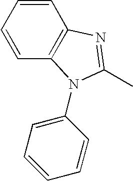 | 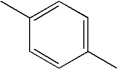 | 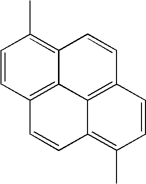 | 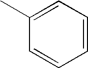 |
| 10 | 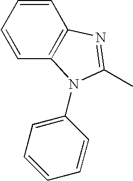 | 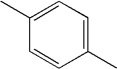 | 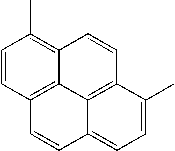 | 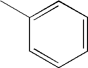 |
| 11 | 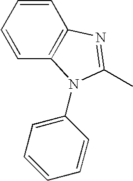 | 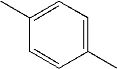 | 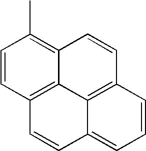 | 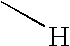 |
| 12 | 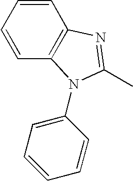 | 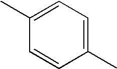 | 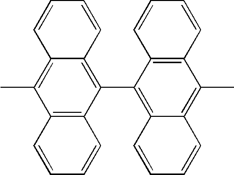 | 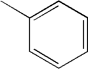 |
| 13 | 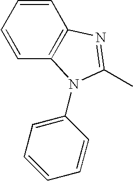 | 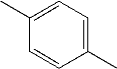 | 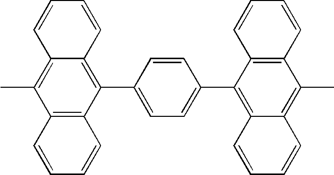 | 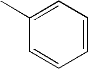 |
| 9-1 | 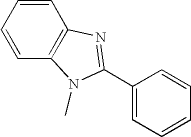 | 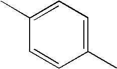 | 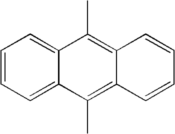 | 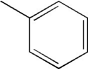 |
| 2 | 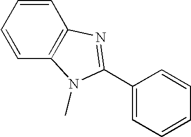 | 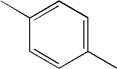 | 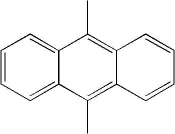 | 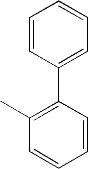 |
| 3 | 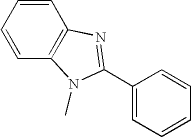 | 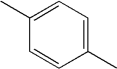 | 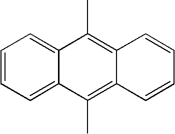 | 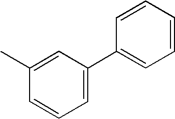 |
| 4 | 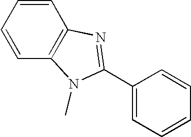 | 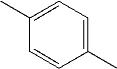 | 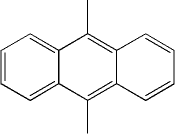 | 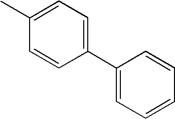 |
| 5 | 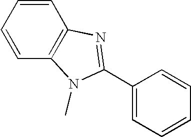 | 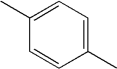 | 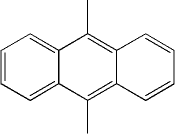 | 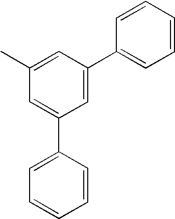 |
| 6 | 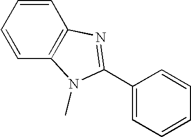 | 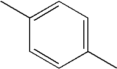 | 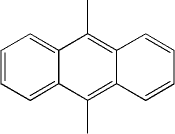 | 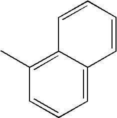 |
| 7 | 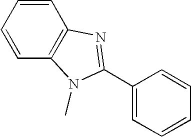 | 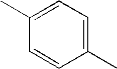 | 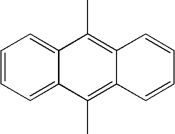 | 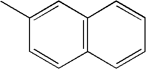 |
| 8 | 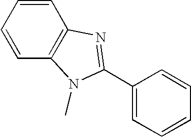 | 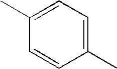 | 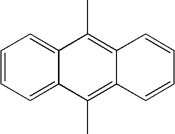 | 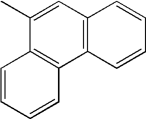 |
| 9 | 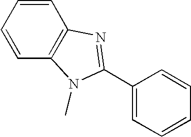 | 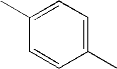 | 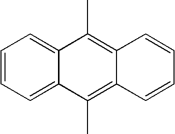 | 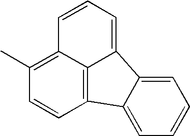 |
| 10 | 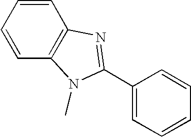 | 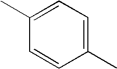 | 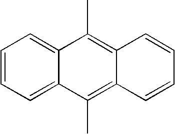 | 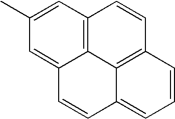 |
| 11 | 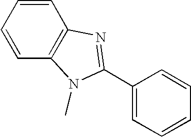 | 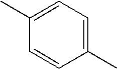 | 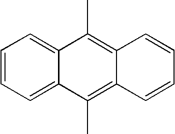 | 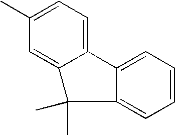 |
| 12 | 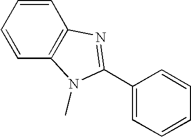 | 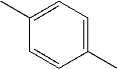 | 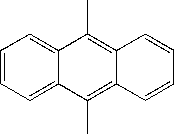 | 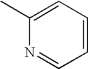 |
| 13 | 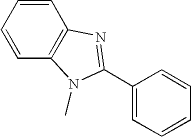 | 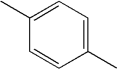 | 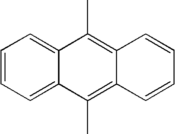 | 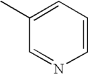 |
| 14 | 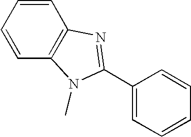 | 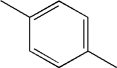 | 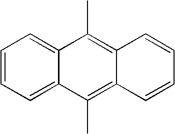 | 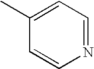 |
| 10-1 | 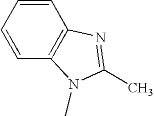 | 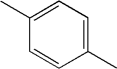 | 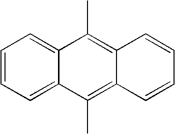 | 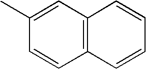 |
| 2 | 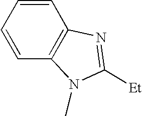 | 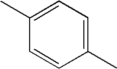 | 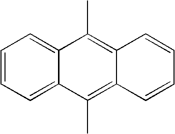 | 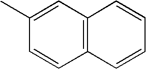 |
| 3 | 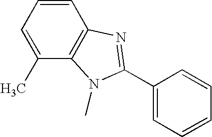 | 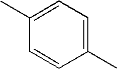 | 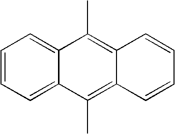 | 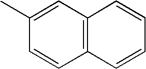 |
| 4 | 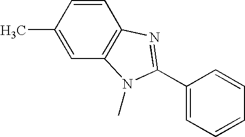 | 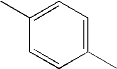 | 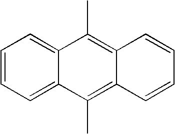 | 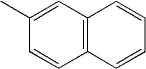 |
| 5 | 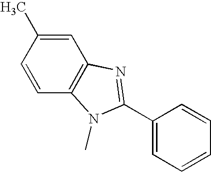 | 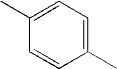 | 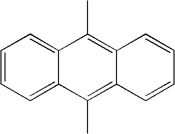 | 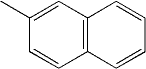 |
| 6 | 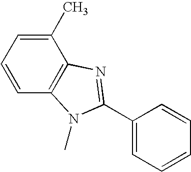 | 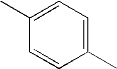 | 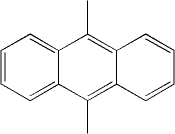 | 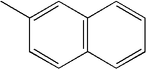 |
| 7 | 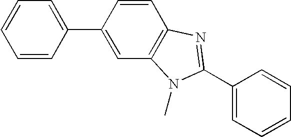 | 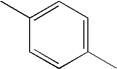 | 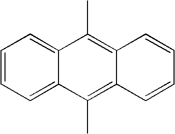 | 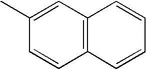 |
| 8 | 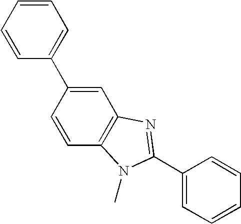 | 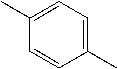 | 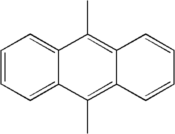 | 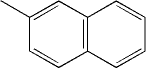 |
| 9 | 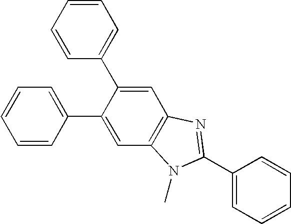 | 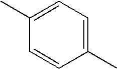 | 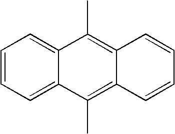 | 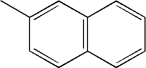 |
| 11-1 | 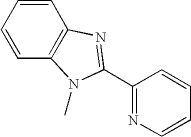 | 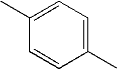 | 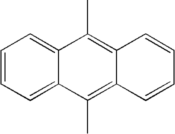 | 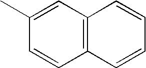 |
| 2 | 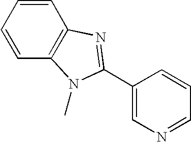 | 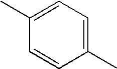 | 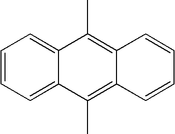 | 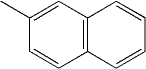 |
| 3 | 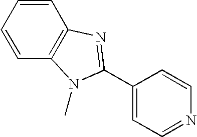 | 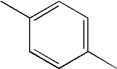 | 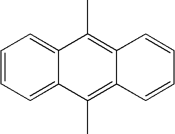 | 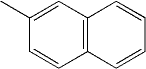 |
| 4 | 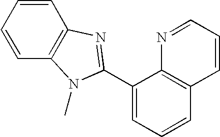 | 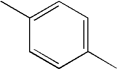 | 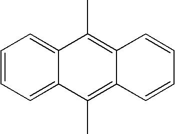 | 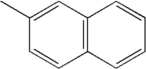 |
| 5 | 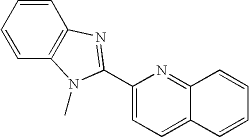 | 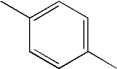 | 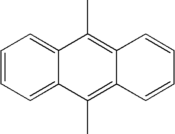 | 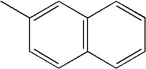 |
| 6 | 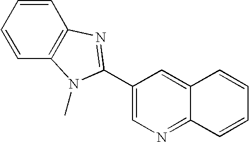 | 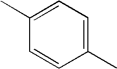 | 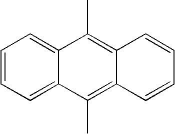 | 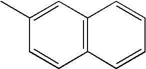 |
| 12-1 | 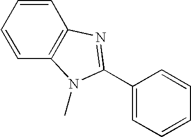 | 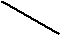 | 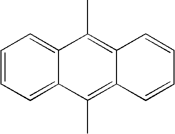 | 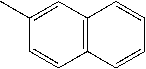 |
| 2 | 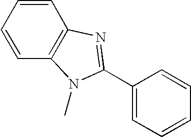 | 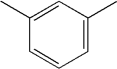 | 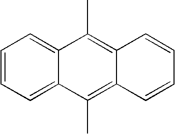 | 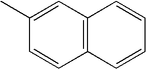 |
| 3 | 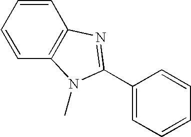 | 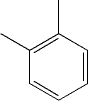 | 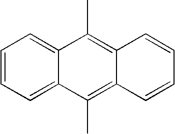 | 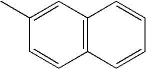 |
| 4 | 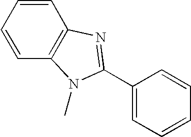 | 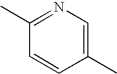 | 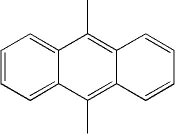 | 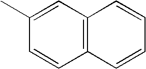 |
| 5 | 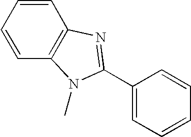 | 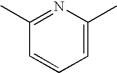 | 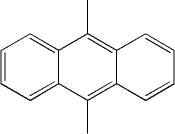 | 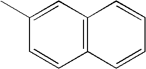 |
| 6 | 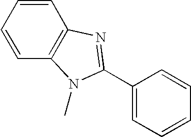 | 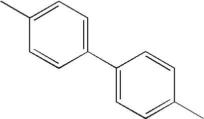 | 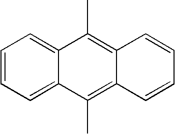 | 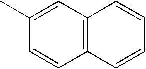 |
| 7 | 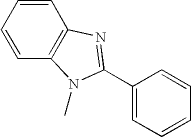 | 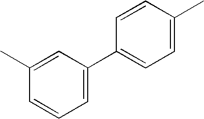 | 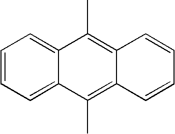 | 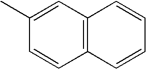 |
| 8 | 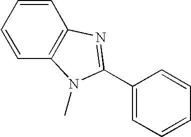 | 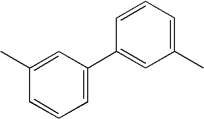 | 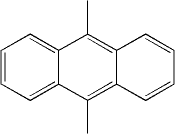 | 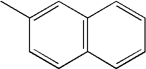 |
| 9 | 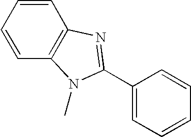 | 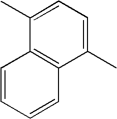 | 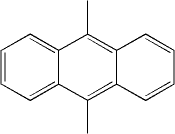 | 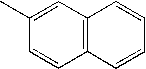 |
| 10 | 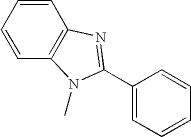 | 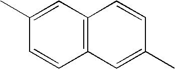 | 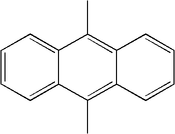 | 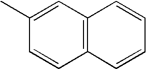 |
| 11 | 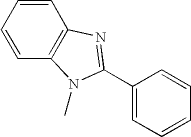 | 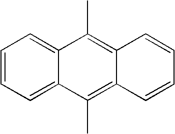 | 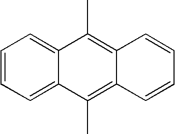 | 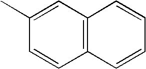 |
| 13-1 | 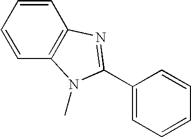 | 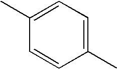 | 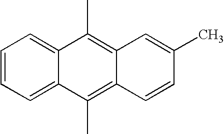 | 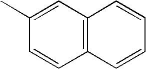 |
| 2 | 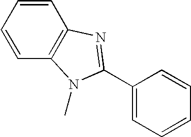 | 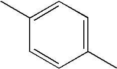 | 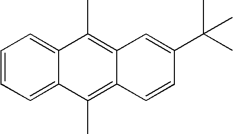 | 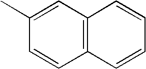 |
| 3 | 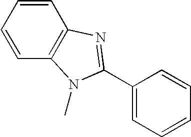 | 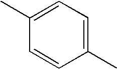 | 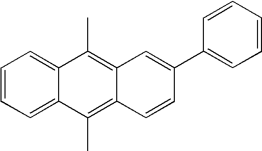 | 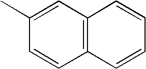 |
| 4 | 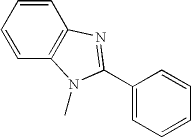 | 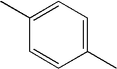 | 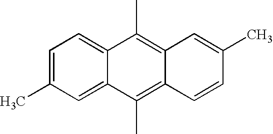 | 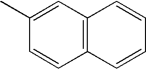 |
| 5 | 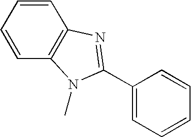 | 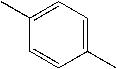 | 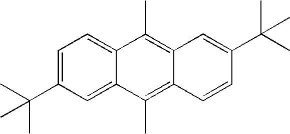 | 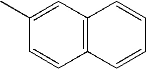 |
| 6 | 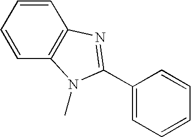 | 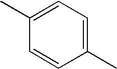 | 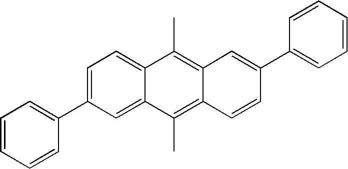 | 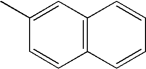 |
| 14-1 | 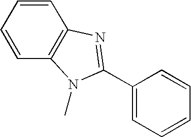 | 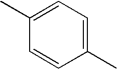 | 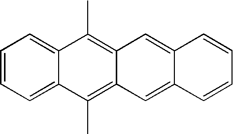 | 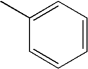 |
| 2 | 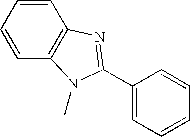 | 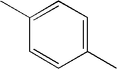 | 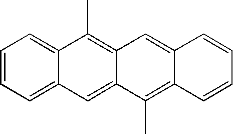 | 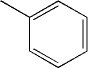 |
| 3 | 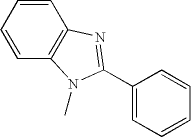 | 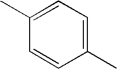 | 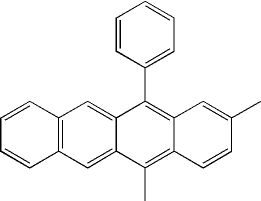 | 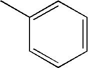 |
| 4 | 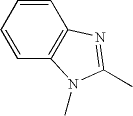 | 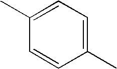 | 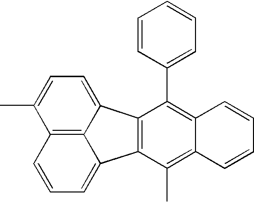 | 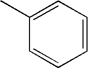 |
| 5 | 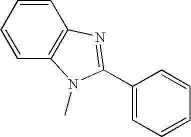 | 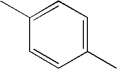 | 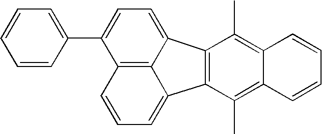 | 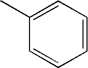 |
| 15-1 | 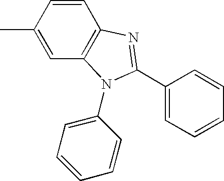 | 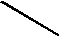 | 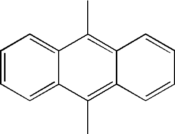 | 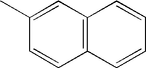 |
| 2 | 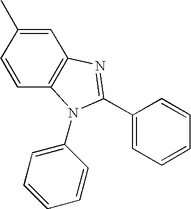 | 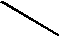 | 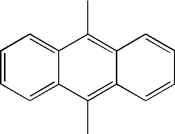 | 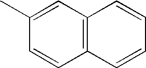 |
| 3 | 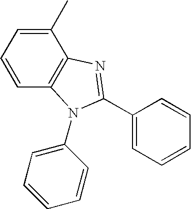 | 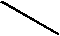 | 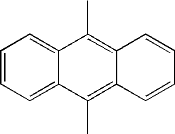 | 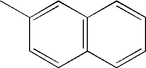 |
| 4 | 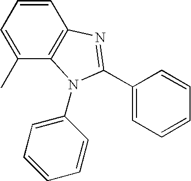 | 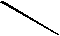 | 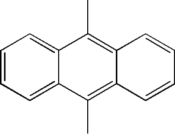 | 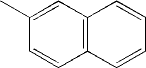 |
| 5 | 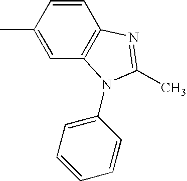 | 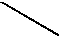 | 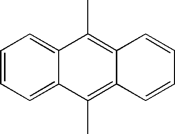 | 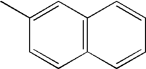 |
| 6 | 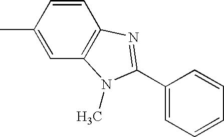 | 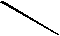 | 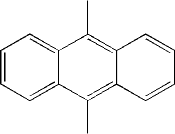 | 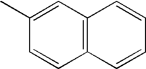 |
| 7 | 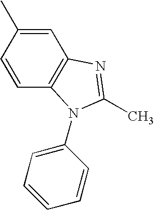 | 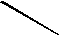 | 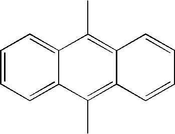 | 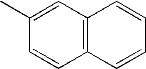 |
| 8 | 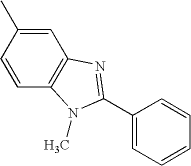 | 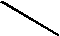 | 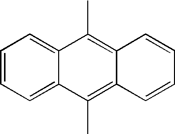 | 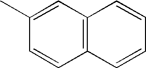 |
| 9 | 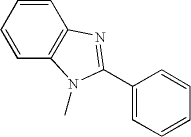 | 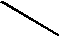 | 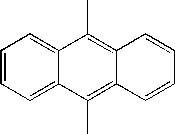 | 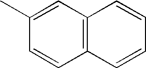 |
| 10 | 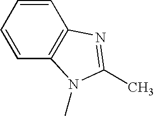 | 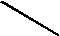 | 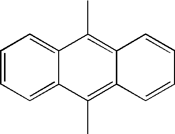 | 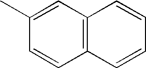 |
| 16-1 | 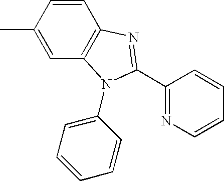 | 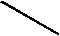 | 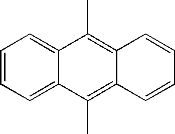 | 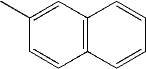 |
| 2 | 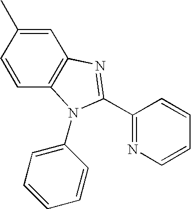 | 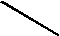 | 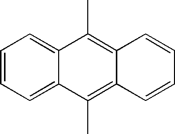 | 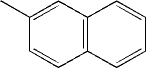 |
| 3 | 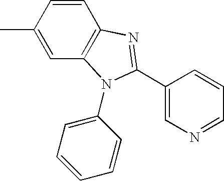 | 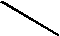 | 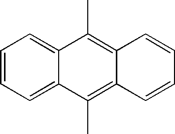 | 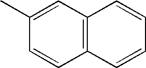 |
| 4 | 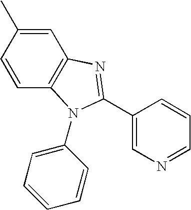 | 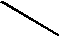 | 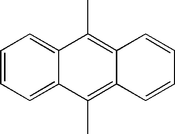 | 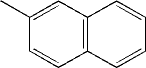 |
| 5 | 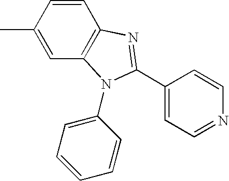 | 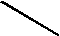 | 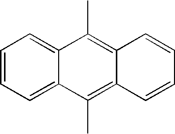 | 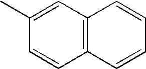 |
| 6 | 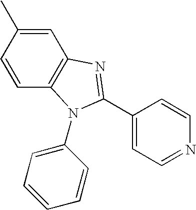 | 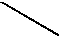 | 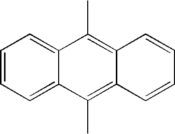 | 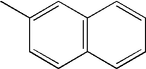 |
| 7 | 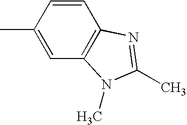 | 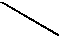 | 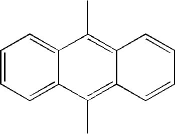 | 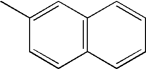 |
| 8 | 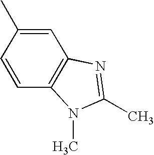 | 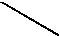 | 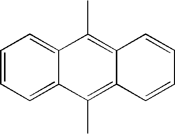 | 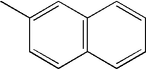 |
| 17-1 | 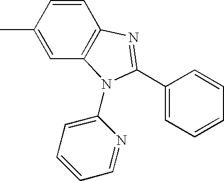 | 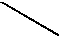 | 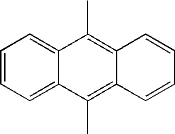 | 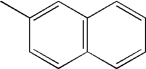 |
| 2 | 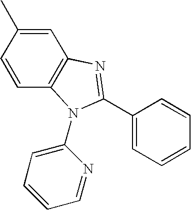 | 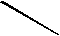 | 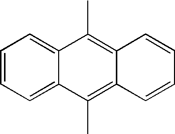 | 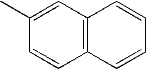 |
| 3 | 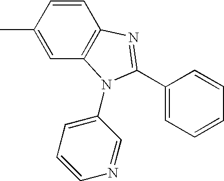 | 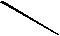 | 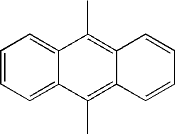 | 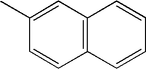 |
| 4 | 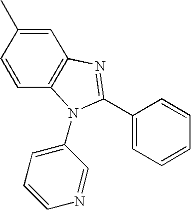 | 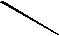 | 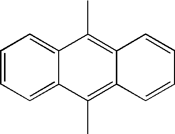 | 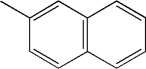 |
| 5 | 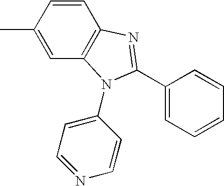 | 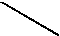 | 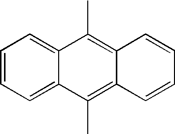 | 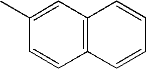 |
| 6 | 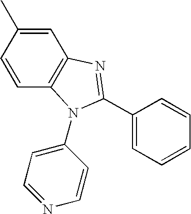 | 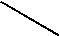 | 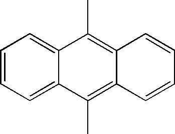 | 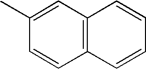 |
| 7 | 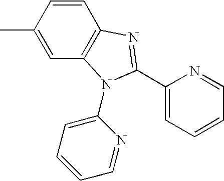 | 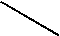 | 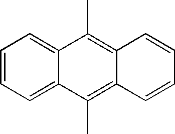 | 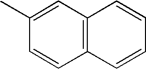 |
| 8 | 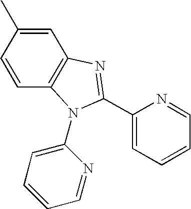 | 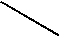 | 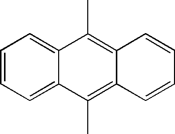 | 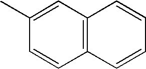 |

Of the above specific examples, (1-1), (1-5), (1-7), (2-1), (3-1), (4-2), (4-6), (7-2), (7-7), (7-8), (7-9), and (9-7) are especially preferable.

The electron injecting layer 133B, for enhancing electron injecting property by effectively preventing leakage of electric current between the cathode 14 and the organic layer 13, is formed of an insulator, semiconductor, or the like.

Next, a manufacturing method of an OELD 1 will be described.

A preparation example of an OELD in which the anode 12, the hole transporting layer 131A, the emitting layer 132, the electron injecting layer 133B, and the cathode 14 are sequentially provided on the light-transmissive substrate 11 will be described.

First, a film is formed of anode materials at a thickness of 1 μm or less, preferably between 10 nm and 200 nm, by vapor deposition, sputtering, or the like on an appropriate light-transmissive substrate 11.

Next, the hole transporting layer 131A is provided on the anode 12.

The hole transporting layer 131A can be formed by vacuum deposition, spin coating, casting, LB method or the like, but is preferably formed by coating method.

It is preferable that the thickness be appropriately selected in a range from 5 nm to 5 μm.

Next, the emitting layer 132 is formed by coating process.

More specifically, a host material, a first dopant material, and a second dopant material, each in a predetermined amount, is dissolved in a solvent to provide an organic EL material containing solution.

For this organic-electroluminescent-material-containing solution, a coating method such as spin coating, casting, microgravure coating, gravure coating, bar coating, roll coating, wire bar coating, dip coating, spray coating, screen printing, flexographic printing, offset printing, or the like may be employed.

Screen printing, flexographic printing, offset printing, inkjet printing, and the like, in which pattern formation and coloring distinctively in multiple colors, are preferable.

Examples of solvent include aromatic solvents which may include an alkoxy group or halogen, such as benzene, toluene, xylene, ethylbenzene, diethylbenzene, ethylbiphenyl, isopropylbiphenyl, anisole, chlorobenzene, dichlorobenzene, chlorotoluene, and the like.

Halogenated hydrocarbon type solvent such as dichloromethane, dichloroethane, chloroform, carbon tetrachloride, tetrachloroethane, or trichloroethane is used as solvent. Ether type solvent such as dibutyl ether, tetrahydrofuran, or dioxane is also used as a solvent.

A viscosity control reagent may be mixed into the organic-electroluminescent-material-containing solution to control the viscosity of the organic-electroluminescent-material-containing solution. The viscosity control reagent includes, for example, an alcohol type solution, ketone type solution, paraffin type solution, alkyl-substituted aromatic solution, and the like. It is preferable that the alcohol type solution or the alkyl-substituted aromatic solution be employed.

Examples of the alcohol type solution include methanol, ethanol, propanol, n-butanol, s-butanol, 2-methyl-1-butanol, 2-methyl-2-butanol, 3-methyl-2-butanol, t-butanol, n-pentanol, 4-methyl-2-pentanol, 3-methyl-1-pentyne-3-ol, n-hexanol, 2-ethylhexanol, 3,5-dimethyl-1-hexyn-3-ol, n-heptanol, 3,3,5-trimethylhexanol, 3-heptanol, n-octanol, 2-octanol, n-nonanol, n-decanol, methylcyclohexanol, cyclohexanol, α-terpineol, neopentyl alcohol, glycidol, methyl cellosolve, ethyl cellosolve, ethylene glycol, propanediol, butanediol, benzyl alcohol, and the like. The alcohols mentioned above may be linear or branched.

The alkyl-substituted aromatic solution includes linear or branched butylbenzene, dodecylbenzene, tetralin, cyclohexylbenzene, dicyclohexylbenzene, 1,1-bis(3,4-dimethylphenyl)ethane, 3-methyldiphenyl ether, and the like.

The viscosity control reagents may be used alone or in combination of a plurality thereof.

Next, the electron injecting layer 133B is provided on the emitting layer 132.

The electron injecting layer 133B may be formed by vacuum deposition, but may also be formed by a coating method.

Lastly, the cathode 14 is layered to obtain the OELD 1.

The cathode 14 is formed of metal by vapor deposition, sputtering, or the like.

It should be noted that vacuum deposition is preferable to prevent the organic layer 13 (base layer) from being damaged during the film-formation.

The thickness of each organic layer of the OELD 1 is not particularly limited. However, since too small a thickness is likely to cause defects such as a pin hole whereas too large a thickness requires high voltage to be applied and decreases efficiency, generally a thickness within a range from several nm to 1 μm is preferable.

Incidentally, in the case of applying direct voltage to the OELD 1, by arranging the anode 12 to have positive polarity and the cathode 14 to have negative polarity and applying voltage from 5 to 40 V, light emission can be observed. When the voltage is applied to an inversely-polarized arrangement, the current does not pass through, so that light emission does not take place. In the case of applying alternating current, uniform light emission is observed only if the anode 12 has the positive polarity and the cathode 14 has the negative polarity. Alternating current of any waveform may be applied.

### EXAMPLES

Examples of the present invention will be described in detail below, but the present invention is not limited to the examples.

Note that the properties of compounds used in the examples and devices prepared were evaluated in the following manner.

(1) Energy gap: energy gap was measured from an absorption end of absorption spectrum of benzene. To be specific, the absorption spectrum is measured with a commercially available ultraviolet-visible spectrophotometer, and the energy gap is calculated from a wavelength at which the absorption spectrum appears.
(2) Luminance: luminance was measured by a spectroradiometer (CS-1000 manufactured formerly by Minolta Co., Ltd, now by Konica Minolta Sensing, Inc.).
(3) Luminous intensity of maximum wavelength of light emission: a single layer film of an emitting layer (a first emitting layer) only including the first dopant as a dopant and a single layer film of an emitting layer (a second emitting layer) only including the second dopant as a dopant were prepared under the same condition as an electroluminescence device (hereafter abbreviated to EL device) to be prepared. A fluorescence spectrum of each of the single layer films was measured by a commercially available fluorescence meter. A fluorescent intensity Iₐ of the first emitting layer at the luminescent maximum wavelength a of the first emitting layer was measured from the acquired fluorescence spectrum of the first emitting layer. Similarly, a fluorescent intensity I_{b} of the second emitting layer at the luminescent maximum wavelength b of the second emitting layer from the obtained fluorescence spectrum of the second emitting layer was prepared.

If the luminescent maximum wavelengths of the first and second emitting layers are sufficiently apart from each other, luminous intensities Iₐ and I_{b} at wavelengths of a and b of the luminescence spectrum of the EL device can respectively approximate I₁ and I₂.

If the luminescent maximum wavelengths of the first emitting layer and the second emitting layer are close to each other, the luminescence spectrum of the EL device can be assumed to be a sum of the luminescence spectrum from the first emitting layer and the luminescence spectrum from the second emitting layer.

Accordingly, in the obtained fluorescence spectrum of the first emitting layer, fluorescent intensities I₁ₐ and I_{1b} of the wavelengths a and b were observed. Similarly, in the fluorescence spectrum of the second emitting layer, fluorescent intensities I₂ₐ and I_{2b} of the wavelengths a, b were observed. The following formulae stand for I₁ and I₂.

Iₐ=I₁*I₁ₐ+I₂*I₂ₐ

I_{b}=I₁*I_{1b}+I₂*I_{2b}

A ratio of I₁ and I₂ was obtained from the above formulae.

(4) Luminous efficiency: a luminous efficiency was calculated from a current density measured by a multimeter and luminance (100 nit).
(5) CIE color coordinate: CIE color coordinates were measured and obtained in the same manner as (2).
(6) Half life: a device sealed under conditions of initial luminance of 1000 nit and a constant current was measured at room temperature.
(7) Electron mobility: The electron mobility was calculated by a Time of flight method. In specific, an object having a configuration of ITO/organic layer (electron injecting layer and the like, thickness of layer 1 to 2 μm)/Al was measured for a time characteristic of transient current generated by light irradiation (transient characteristic time), and the electron mobility was calculated by the following formulae.

electron mobility=(thickness of organic layer)²/(transient characteristic time−electric intensity)

Compounds used in the examples will be shown below.

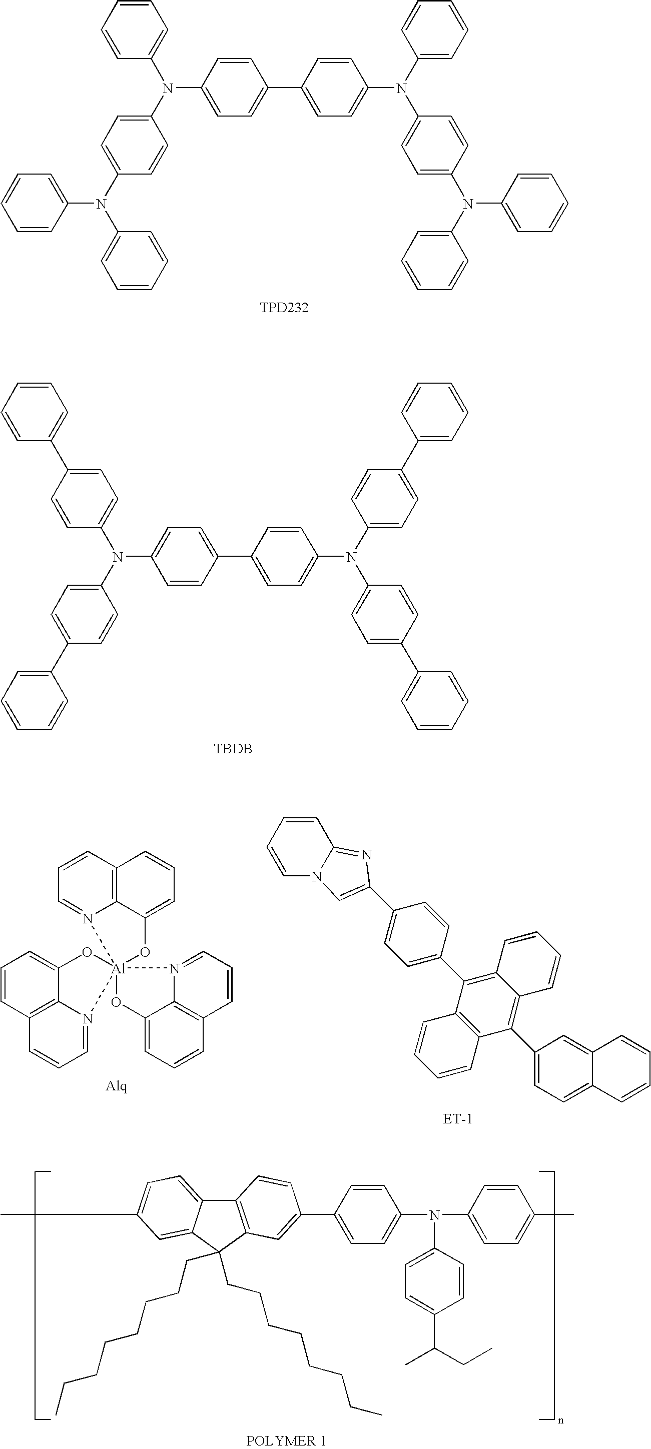

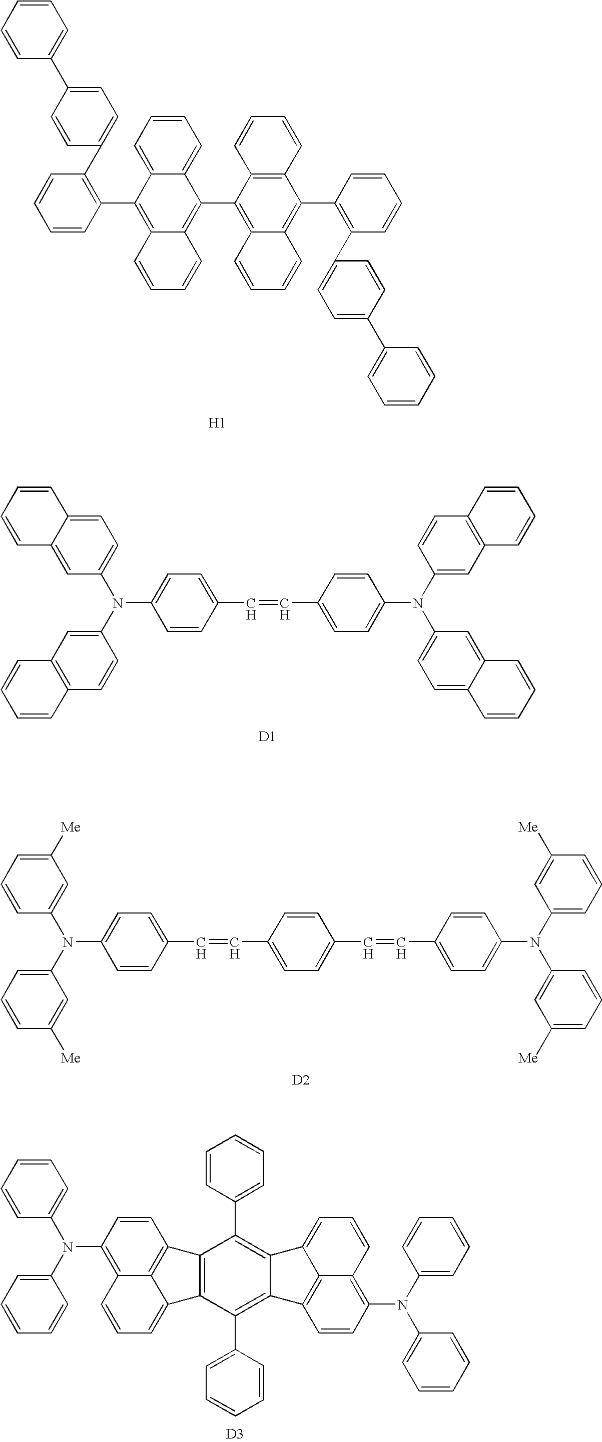

Data of energy gap, affinity level, and electron mobility of the above compounds were as follows.

For D1, Eg=2.9 eV, Af=2.5 eV

For H1, Eg=3.0 eV, Af=2.7 eV

For D2, Eg=2.8 eV, Af=2.8 eV

### For D3, Eg=2.6 eV, Af=3.0 eV

Electron mobility of ET-1 is 4*10⁻⁴ cm²/V·s (provided being in an electric field of E=5*10⁵ V/cm)

Electron mobility of Alq is 5*10⁻⁶ cm²/V·s (provided being in an electric field of E=5*10⁵ V/cm).

### Comparative Example 1

A glass substrate of 25 mm*75 mm*1.1 mm (thickness) having an ITO transparent electrode (manufactured by Geomatec Co., Ltd) went through 5 minutes of ultrasonic cleaning in isopropyl alcohol and then 30 minutes of UV ozone cleaning.

On the glass substrate with a transparent electrode that has been cleaned, a mixture of polyethylene-dioxy-thiophene/polystyrene sulphonic acid (PEDOT.PSS) used for a hole injecting layer was formed into a 50 nm thick film by spin coating.

Next, a toluene solution (0.6% by mass) of the above polymer 1 (Mw: 145000) was formed into a 20 nm thick film before it was dried at 170° C. for 30 minutes.

After that, the film-formed substrate was transferred to a vacuum deposition device.

An emitting layer was constituted by two layers. 20 nm of the dopant D1 and the host H1 (at a doping concentration of 5% by mass) made the first emitting layer, and 20 nm of the dopant D2/the host H1 (5% by mass) made the second emitting layer, which were sequentially formed by vapor deposition.

A 20 nm thick tris(8-quinolinol)aluminum film (hereafter abbreviated to “Alq film”) was formed on this film.

This Alq film functioned as an electron transporting layer.

Lithium fluoride was formed into a film of 1 nm as an electron injecting layer on this.

Lastly, aluminum was formed into a film of 150 nm to constitute a cathode.

When current was delivered to evaluate the performance, luminance 6.7 cd/A, chromaticity (0.15, 0.17), half life LT50=3000 h at 1000 cd/m², drive voltage=6.5 V at 10 mA/cm², ratio of luminous intensities I₁/I₂=80/20 were obtained.

### Comparative Example 2

A device was prepared in the same manner as the comparative example 1 except that the emitting layer was a 40 nm thick single layer and that 5% by mass of the dopant D1 and 1% by mass of the dopant D2 were doped to the host H1.

As a result, luminance 10 cd/A, chromaticity (0.15, 0.30), half life LT 50=5000 h at 1000 cd/m², drive voltage=6.5 V at 10 mA/cm², ratio of luminous intensities I₁/I₂=0/100 were obtained.

That is to say, though the doping concentration was low, light emission by the second dopant D2 was now the only light emission, which was in blue green.

### Comparative Example 3

In the comparative example 1, the concentration of the second dopant D2 of the second emitting layer was changed to 1% by mass.

A device was prepared otherwise in the same manner as the comparative example 1.

As a result, 7.0 cd/A, chromaticity (0.15, 0.16), half life LT50=3000 h at 1000 cd/m², voltage 6.5 V at 10 mA/cm², ratio of luminous intensities I₁/I₂=90/10 were obtained.

Color purity improved as the light emission of the second dopant decreased, but effect was insufficient in terms of lifetime extension.

### Comparative Example 4

In the comparative example 1, the first emitting layer was now the only emitting layer, whose thickness was changed to 40 nm, and ET-1 was formed as an electron transporting layer by vapor deposition. A device was prepared otherwise in the same manner as the comparative example 1.

As a result, luminance 8 cd/A, chromaticity (0.15, 0.15), half life LT50=300 h, drive voltage=3.5 V at 10 mA/cm², a ratio of luminous intensities I₁/I₂=100/0 were obtained.

Since ET-1 was employed for an electron transporting layer, the drive voltage decreased, but the lifetime was shorter than the comparative example 1.

### Example 1

In the comparative example 4, the emitting layer was formed in a coating method.

That is, cyclohexanone was used as a solvent, to which 5% by mass of the dopant D1 and 0.5% by mass of the dopant D2 were doped to prepare a solution, from which an emitting layer constituted of a single layer was formed by spin coating. The emitting layer was 20 nm thick.

A device was prepared otherwise in the same manner as the comparative example 4.

As a result, luminance of 8 cd/A, chromaticity (0.15, 0.16), half life LT 50=4000 h at 1000 cd/m², drive voltage=3.5 V at 10 mA/cm², ratio of luminous intensities I₁/I₂=95/5 were obtained.

By thinly doping the second dopant D2 to the emitting layer of a single layer, light emission was reduced to one from the first dopant D1, the lifetime was longer than the comparative example 1, and the drive voltage decreased by 3V on account of absence of the second emitting layer unlike the comparative example 1.

### Example 2

A device was prepared in the same manner as the example 1 except that the same electron transporting layer was formed as the comparative example 1.

As a result, luminance 7 cd/A, chromaticity (0.15, 0.16), half life LT 50=5000 h at 1000 cd/m², drive voltage=6.5 V at 10 mA/cm², ratio of luminous intensities I₁/I₂=95/5 were obtained.

The voltage rose compared to the example 1, but the lifetime extended further, and fine chromaticity was observed.

### Example 3

A device was prepared in the same manner as the example 1 except that a concentration of the second dopant D2 was 0.01% by mass.

As a result, luminance 8 cd/A, chromaticity (0.15, 0.15), half life LT50=3800 h at 1000 cd/m², drive voltage=3.5 V at 10 mA/cm², ratio of luminous intensities I₁/I₂=99/1 were obtained.

### Example 4

The same preparation as in the example 1, was conducted except that the D2 was doped in 0.4% by mass.

Hereinafter, see a table 1 below for the results.

### Example 5

A device was prepared in the same manner as the example 1 except that a concentration of the second dopant D2 was 0.05% by mass.

### Example 6

A device was prepared in the same manner as the example 1 except that a concentration of the second dopant D2 was 0.03% by mass.

### Example 7

The same preparation as in the example 1 was conducted except that the D2 was changed to D3, which was doped in 0.05% by mass.

### Example 8

The same preparation as in the example 1 was conducted except that the D2 was changed to D3, which was doped in 0.3% by mass.

TABLE 1

| | Doping | | | Current | | | | | Ratio of |
|---|---|---|---|---|---|---|---|---|---|
| | Concentration | | | Efficiency | | | Half Life | | Luminous |
| | (mass %) | | | L/J | Chromaticity | | LT50*² | Voltage*² | Intensities |
| | D1 | D2 | D3 | (cd/A) | x | y | (hr) | (V) | I₁/I₂ |
| Comparative | 5.0 | 5.0 | — | 6.7 | 0.15 | 0.17 | 3000 | 6.5 | 80/20 |
| Example 1 | | | | | | | | | |
| Comparative | 5.0 | 1.0 | — | 10.0 | 0.15 | 0.3 | 5000 | 6.5 | 0/100 |
| Example 2 | | | | | | | | | |
| Comparative | 5.0 | 1.0 | — | 7.0 | 0.15 | 0.3 | 3000 | 6.5 | 0/100 |
| Example 3 | | | | | | | | | |
| Comparative | 5.0 | — | — | 8.0 | 0.15 | 0.15 | 300 | 3.5 | 100/0 |
| Example 4 | | | | | | | | | |
| Example 1 | 5.0 | 0.5 | — | 8.0 | 0.15 | 0.16 | 4000 | 3.5 | 95/5 |
| Example 2 | 5.0 | 0.5 | — | 7.0 | 0.15 | 0.16 | 5000 | 6.5 | 95/5 |
| Example 3 | 5.0 | 0.01 | — | 8.0 | 0.15 | 0.15 | 3800 | 3.5 | 99/1 |
| Example 4 | 5.0 | 0.4 | — | 8.0 | 0.15 | 0.16 | 3800 | 3.5 | 96/4 |
| Example 5 | 5.0 | 0.05 | — | 8.0 | 0.15 | 0.15 | 3500 | 3.5 | 98/2 |
| Example 6 | 5.0 | 0.3 | — | 8.0 | 0.15 | 0.15 | 3800 | 3.5 | 97/3 |
| Example 7 | 5.0 | — | 0.05 | 8.0 | 0.15 | 0.16 | 5000 | 3.5 | 98/2 |
| Example 8 | 5.0 | — | 0.3 | 8.5 | 0.16 | 0.16 | 5000 | 3.5 | 97/3 |

*¹In the case of 1000 cd/m²
*²In the case of 10 mA/cm²

If the examples 1 to 8 are compared to the comparative example 4, whereas the emitting layer is a single layer and the primarily-emitting first dopant is the only dopant contained in the comparative example 4, a single emitting layer contains not only the primarily-emitting first dopant but also a small amount of the second dopant in the examples 1 to 8.

In all of the comparative example 4 and the examples 1 to 8, the chromaticity is substantially the same, properly being blue, but the lifetime is enormously longer in the examples 1 to 8.

Accordingly, it has been shown that by containing a first dopant and a small amount of a second dopant in one emitting layer as is the case in the present invention, a device possessing a very long lifetime and at the same time a fine color purity can be prepared.

Further, from the comparison between the comparative example 1 and the examples 1 to 8, similar effects can be expected in a case like comparative example 1 where an emitting layer includes two layers, one of which is a first emitting layer containing a first dopant and the other is a second emitting layer containing a second dopant, but it has been shown that the arrangement of the present invention can extraordinarily improve the color purity and the lifetime.

Furthermore, though color purity is somewhat improved if the emitting layer includes the two layers and the concentration of the second dopant D2 in the second emitting layer is reduced as have been done in the comparative example 3 to rectify the disadvantageous color purity of the comparative example 1, since the emitting layer is divided into two, lifetime-extending effects on par with the examples of the present invention are not provided.

Incidentally, it would only prove impossible to provide a lower concentration of the second dopant in the second emitting layer than the comparative example 3 by vapor deposition, which makes it necessary to, similarly to the examples, employ a coating method to lower the dopant concentration.

It should be noted that the present invention is not limited to the above embodiments and the examples, but is permissive of modification without diverting from the inventive concept of the present invention.

A content ratio of the second dopant is not limited to the above examples, where the second dopant may be contained in any amount as far as the ratio of the luminous intensities of the first dopant and the second dopant is twelve times or larger.

An energy gap of the second dopant may preferably be smaller than an energy gap of the first dopant, but an energy gap of the second dopant may be larger than an energy gap of the first dopant as well. In this case, a function as an electron trap is still provided if an Af of the second dopant is larger by 0.2 eV or more than an Af of the host.

An electron transporting layer is not limited to the above compounds, but as a matter of course can also be a known electron transporting material, which still provides the effects of the present invention.

Configurations of a device, materials of layers, and the like will be listed below as variations of the present invention, but as a matter of course the present invention is not limited to those listed.

### (1) Configurations of OELD

Device configurations of an OELD will be described hereinafter.

Typical device configurations of an OELD include the following structures (a) to (m) and the like.

(a) anode/emitting layer/cathode
(b) anode/hole injecting layer/emitting layer/cathode
(c) anode/emitting layer/electron injecting layer/cathode
(d) anode/hole injecting layer/emitting layer/electron injecting layer/cathode
(e) anode/organic semiconductor layer/emitting layer/cathode
(f) anode/organic semiconductor layer/electron blocking layer/emitting layer/cathode
(g) anode/organic semiconductor layer/emitting layer/adhesion improving layer/cathode
(h) anode/hole injecting layer/hole transporting layer/emitting layer/electron injecting layer/cathode
(i) anode/insulating layer/emitting layer/insulating layer/cathode
(j) anode/inorganic semiconductor layer/insulating layer/emitting layer/insulating layer/cathode
(k) anode/organic semiconductor layer/insulating layer/emitting layer/insulating layer/cathode
(l) anode/insulating layer/hole injecting layer/hole transporting layer/emitting layer/insulating layer/cathode
(m) anode/insulating layer/hole injecting layer/hole transporting layer/emitting layer/electron injecting layer/cathode

### (2) Light-Transmissive Substrate

An OELD is prepared on a light-transmissive substrate. Here, a light-transmissive substrate, which is a substrate for supporting OELDs, preferably is a smooth substrate whose transmittance of visible light from 400 nm to 700 nm is 50% or more

Specifically, a glass plate, a polymer plate, and the like are preferable.

To be more specific, the glass plate includes soda-lime glass, barium/strontium-containing glass, lead glass, aluminosilicate glass, borosilicate glass, barium borosilicate glass, quartz, and the like.

The polymer plate includes polycarbonate, acryl, polyethylene terephthalate, polyether sulfide, polysulfone and the like.

### (3) Anode

A task of an anode of an OELD is to inject a hole to a hole transporting layer or an emitting layer, so that possession of a work function of 4.5 eV or greater is effective. Examples of anode materials include indium-tin oxide (ITO), tin oxide (NESA), indium zinc oxide (IZO), gold, silver, platinum, copper, and the like.

An anode can be prepared by forming a thin film out of these electrode materials by vapor deposition, sputtering, or the like.

When light emission from an emitting layer is acquired from an anode, it is preferable that the anode possess 10% or more of transmittance for light emission. It is also preferable that sheet resistance of the anode be equal to or less than several hundred Ω/□. Though dependent on material, a thickness of an anode is preferably selected normally within a range from 10 nm to 1 μm and preferably within a range from 10 to 200 nm.

### (4) Hole Injecting and Transporting Layer

Hole injecting and transporting layers, which help injecting holes to an emitting layer and transport holes to an emitting region, has a high hole mobility and normally has a small ionization energy of 5.5 eV or less. It is preferable that such hole injecting and transporting layers be materials which transport holes to an emitting layer at a lower electric intensity, and further preferable that a hole mobility be, for example, at least 10⁻⁴ cm²/V·sec when applied an electrical field of 10⁴ to 10⁶ V/cm.

Materials that form hole injecting and transporting layers are not particularly limited as far as the above preferable characteristics are exhibited, and may appropriately be selected from materials that have conventionally been used as materials for transporting electric charges of holes in photoconducting materials or known materials used for a hole injecting layer of an OELD.

Examples include a triazole derivative (See, U.S. Pat. No. 3,112,197 etc.), oxadiazole derivative (See, U.S. Pat. No. 3,189,447 etc.), imidazole derivative (See, JP-B-37-16096 etc.), polyarylalkane derivative (See, U.S. Pat. No. 3,615,402, U.S. Pat. No. 3,820,989, U.S. Pat. No. 3,542,544, JP-B-45-555, JP-B-51-10983, JP-A-51-93224, JP-A-55-17105, JP-A-56-4148, JP-A-55-108667, JP-A-55-156953, JP-A-56-36656, etc.), pyrazoline derivative and pyrazolone derivative (See, U.S. Pat. No. 3,180,729, U.S. Pat. No. 4,278,746, JP-A-55-88064, JP-A-55-88065, JP-A-49-105537, JP-A-55-51086, JP-A-56-80051, JP-A-56-88141, JP-A-57-45545, JP-A-54-112637, JP-A-55-74546, etc.), phenylenediamine derivative (See, U.S. Pat. No. 3,615,404, JP-B-51-10105, JP-B-46-3712, JP-B-47-25336, JP-A-54-53435, JP-A-54-110536, JP-A-54-119925, etc.), arylamine derivative (See, U.S. Pat. No. 3,567,450, U.S. Pat. No. 3,180,703, U.S. Pat. No. 3,240,597, U.S. Pat. No. 3,658,520, U.S. Pat. No. 4,232,103, U.S. Pat. No. 4,175,961, U.S. Pat. No. 4,012,376, JP-B-49-35702, JP-B-39-27577, JP-A-55-144250, JP-A-56-119132, JP-A-56-22437, F.R.G. Patent No. 1,110,518 etc.), amino-substituted chalcone derivative (See, U.S. Pat. No. 3,526,501 etc.), oxazole derivative (that disclosed in U.S. Pat. No. 3,257,203 etc.), styrylanthracene derivative (See, JP-A-56-46234 etc.), fluorenone derivative (See, JP-A-54-110837 etc.), hydrazone derivative (See, U.S. Pat. No. 3,717,462, JP-A-54-59143, JP-A-55-52063, JP-A-55-52064, JP-A-55-46760, JP-A-55-85495, JP-A-57-11350, JP-A-57-148749, JP-A-02-311591, etc.), stilbene derivative (See, JP-A-61-210363, JP-A-61-228451, JP-A-61-14642, JP-A-61-72255, JP-A-62-47646, JP-A-62-36674, JP-A-62-10652, JP-A-62-30255, JP-A-60-93455, JP-A-60-94462, JP-A-60-174749, JP-A-60-175052, etc.), silazane derivative (U.S. Pat. No. 4,950,950), polysilane type (JP-A-02-204996), aniline-type copolymer (JP-A-02-282263), conductive high-molecular oligomer disclosed in JP-A-1-211399 (particularly thiophene oligomer), and the like.

In addition, thiophene polymer such as poly(alkylthiophene)polymer may be employed. Polydioxythiophene, and further, poly(3,4-dioxythiophene) may preferably be employed, for example. Aniline type may be polymer (polyaniline), too.

Besides, the following formula may also be included.

Q¹-G-Q²

(In the formula, Q¹ and Q² are portions having at least one tertiary amine and G is a linking group.)

Still further preferably, an amine derivative represented by the following formula (17) may be employed.

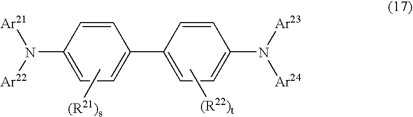

In the above formula (17), Ar²¹ to Ar²⁴ are a substituted or unsubstituted aromatic ring having 6 to 50 ring carbon atoms or substituted or unsubstituted heteroaromatic ring having 5 to 50 ring atoms.

R²¹ and R²² are substituent groups, and the signs s and t are each an integer from 0 to 4.

Ar²¹ and Ar²² may be connected to each other to form a ring structure, and Ar²³ and Ar²⁴ may be connected to each other to form a ring structure.

R²¹ and R²² may also be connected to each other to form a ring structure.

Substituent groups of Ar²¹ to Ar²⁴ and R²¹ and R²² are a substituted or unsubstituted aromatic ring having 6 to 50 ring carbon atoms, substituted or unsubstituted heteroaromatic ring having 5 to 50 ring atoms, alkyl group having 1 to 50 carbons, alkoxy group having 1 to 50 carbons, alkylaryl group having 1 to 50 carbons, aralkyl group having 1 to 50 carbons, styryl group, amino group substituted by an aromatic ring having 6 to 50 ring carbon atoms or by a heteroaromatic ring having 5 to 50 ring atoms, or aromatic ring having 6 to 50 ring carbon atoms or heteroaromatic ring having 5 to 50 ring atoms substituted by an amino group substituted by an aromatic ring having 6 to 50 ring carbon atoms or by a heteroaromatic ring having 5 to 50 ring atoms.

The above materials can be employed as materials for the hole injecting layer, but it is preferable that porphyrin compounds (those disclosed in JP-A-63-2956965 etc.) and aromatic tertiary amine compounds and styrylamine compounds (See, U.S. Pat. No. 4,127,412, JP-A-53-27033, JP-A-54-58445, JP-A-54-149634, JP-A-54-64299, JP-A-55-79450, JP-A-55-144250, JP-A-56-119132, JP-A-61-295558, JP-A-61-98353, JP-A-63-295695, etc.) be employed and further preferable that aromatic tertiary amine compounds be employed.

Another example is a compound disclosed in U.S. Pat. No. 5,061,569, which contains two condensed aromatic rings within the molecules, such as 4,4′-bis(N-(1-naphthyl)-N-phenylamino)biphenyl (hereafter abbreviated to NPD) or the like. Still another example is 4,4′,4″-tris(N-(3-methylphenyl)-N-phenylamino)triphenylamine (hereafter abbreviated to MTDATA) disclosed in JP-A-04-308688, in which three triphenylamine units are connected in starburst fashion, or the like.

Inorganic compounds such as p-type Si, p-type SiC, and the like, as well as aromatic dimethylidine compounds mentioned above as materials for the emitting layer, may also be employed as materials for hole injecting layers.

Besides, it is preferable that at least one layer of an emitting layer and an organic layer between the emitting layer and an anode contain an oxidizing agent, which preferably includes an electron withdrawing compound or an electron acceptor, specifically, a Lewis acid, various quinone derivatives, dicyanoquinodimethane derivative, and salts formed by aromatic amine and Lewis acid and the like, the Lewis acid including iron chloride, antimony chloride, aluminum chloride, and the like.

In addition, a nitrogen-containing heterocycle derivative which is represented by the following formula (18) and is disclosed in Japanese Patent No. 3571977 may also be employed.

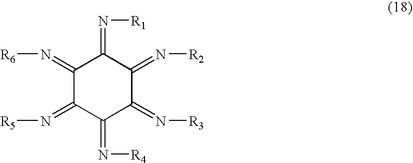

In the above formula (18), R₁ to R₆ represent one of a substituted or unsubstituted alkyl group, substituted or unsubstituted aryl group, substituted or unsubstituted aralkyl group, and substituted or unsubstituted heterocyclic group. Here, R₁ to R₆ may be identical to or different from each other. R₁ and R₂ may form a condensed ring, R₃ and R₄ may form a condensed ring, and so may R₅ and R₆; or R₁ and R₆ may form a ring, R₂ and R₃ may form a ring, and so may R₄ and R₅.

Moreover, compounds represented by the following formula (19) disclosed in US2004/113547 A1 may also be employed.

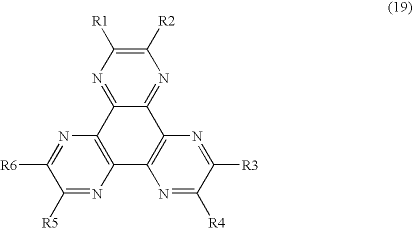

In the above formula (19), R1 to R6 are a substituent group, preferably an electron withdrawing group such as a cyano group, nitro group, sulfonyl group, carbonyl group, trifluoromethyl group, halogen, and the like.

The hole injecting and transporting layers can be formed by film-forming of the above compounds by, for example, vacuum deposition, spin coating, casting, LB method, or the like. Thickness of the hole injecting and transporting layers are not particularly limited, but normally are 5 nm to 5 μm. As far as the hole injecting and transporting layers contain the compounds according to the present invention in the hole transporting zone thereof, the hole injecting and transporting layers may be formed by a singular layer made of one kind or two or more kinds of the above compounds, or may be formed by layers of the hole injecting and transporting layers made of compounds different from the aforementioned hole injecting and transporting layers. The organic semiconductor layer, which is a layer that helps hole injection or electron injection into an emitting layer, appropriately possesses conductivity of 10⁻¹⁰ S/cm or more. For materials of the organic semiconductor layer, conductive oligomer such as thiophene-containing oligomer, arylamine-containing oligomer disclosed in JP-A-08-193191, etc. conductive dendrimer such arylamine-containing dendrimer etc., and the like may be utilized.

### (5) Electron Injecting Layer

Preferred embodiments of an OELD include a device which contains a reductive dopant in an electron transporting region or an interface region between a cathode and an organic layer. Here, a reductive dopant is defined as a material that can reduce an electron transporting compound. Accordingly, various materials are utilized as far as the material possesses proper reductive property. For example, at least one material selected from a group of alkali metal, alkali earth metal, rare earth metal, oxide of alkali metal, halogenide of alkali metal, oxide of alkali earth metal, halogenide of alkali earth metal, oxide of rare earth metal, halogenide of rare earth metal, organic complexes of alkali metal, organic complexes of alkali earth metal, and organic complexes of rare earth metal may suitably be utilized.

More specifically, it is preferable that a reductive dopant possess a work function of 2.9 eV or lower and be at least one alkali metal selected from a group of Li (work function: 2.9 eV), Na (work function: 2.36 eV), K (work function: 2.28 eV), Rb (work function: 2.16 eV), and Cs (work function: 1.95 eV) or at least one alkali earth metal selected from a group of Ca (work function: 2.9 eV), Sr (work function: 2.0 to 2.5 eV), and Ba (work function: 2.52 eV). More preferred of these reductive dopants is at least one alkali metal selected from a group of K, Rb, and Cs, a still more preferred is Rb or Cs, and the most preferred one is Cs. These alkali metals possess especially high reducing property, so that doping to an electron injecting region in a relatively small amount can improve luminance of and extend a lifetime of an OELD. In addition, as a reductive dopant with a work function of 2.9 eV or less, combinations of two or more kinds of alkali metal is also preferable, and a combination which contains Cs such as a combination of Cs and Na, combination of Cs and K, combination of Cs and Rb, or combination of Cs, Na, and K are especially preferable. Since Cs is included in the combinations of the contained materials, reduction is now efficiently achieved, which allows doping to an electron injecting region to improve luminance of and extend lifetime of OELD.

Further, an electron injecting layer formed by an insulator or a semiconductor may be provided between the cathode and the organic layer. At this time, leakage of current is effectively prevented to improve electron injecting property. For such an insulator, at least one metal compound selected from a group of alkali metal chalcogenide, alkaline earth metal chalcogenide, halogenide of alkali metal, and halogenide of alkali earth metal may preferably be utilized. A configuration in which the electron injecting layer is formed by these alkaline metal chalcogenide and the like is advantageous in that the electron injecting property is further improved. Specifically, preferred alkali metal chalcogenide includes, for example, Li₂O, K₂O, Na₂Se and Na₂O, and preferred alkaline earth metal chalcogenide includes, for example, CaO, BaO, SrO, BeO, BaS, and CaSe. Preferred halogenide of alkali metal includes, for example, LiF, NaF, KF, LiCl, KCl, and NaCl and the like. Preferred halogenide of alkali earth metal includes, for example, fluorides such as CaF₂, BaF₂, SrF₂, MgF₂ and BeF₂ and halogenides other than fluorides.

A semiconductor that forms the electron transporting layer includes an oxide, nitride, oxidized nitride, or the like alone or in combination of two or more kinds, which contains at least one element of Ba, Ca, Sr, Yb, Al, Ga, In, Li, Na, Cd, Mg, Si, Ta, Sb, and Zn. Inorganic compounds forming the electron transporting layer may preferably be microcrystalline or amorphous insulative film. If an electron transporting layer is formed by these insulative films, a film with greater uniformity is formed, so that pixel defects such as dark spots can be reduced. Incidentally, such inorganic compounds include the aforementioned alkali metal chalcogenide, alkaline earth metal chalcogenide, halogenide of alkali metal, halogenide of alkali earth metal, and the like.

### (6) Cathode

An electrode material of a cathode is metal, alloy, an electrically conductive compound, and a mixture of these, which possesses a low work function (4 eV or lower) to inject electrons to electron injecting or transporting layers or emitting layers. Specific examples of such electrode materials include sodium, sodium-potassium alloy, magnesium, lithium, magnesium-silver alloy, aluminum/aluminum oxide, aluminum-lithium alloy, indium, rare earth metal, and the like.

These electrode materials are formed into a film by methods such as vapor deposition, sputtering, and the like to prepare the cathode.

Here, when light emission from the emitting layer is acquired from the cathode (in the case of top emission), transmittance as to light emission of the cathode preferably is larger than 10%.

Sheet resistance of the cathode is preferably several Ω/□ or lower, and thickness thereof is normally 10 nm to 1 μm, preferably 50 to 200 nm.

### (7) Insulating Layer

As for an OELD, since an electric field is applied to super thin film, leakage or short circuit is likely to cause a pixel defect. To prevent this, an insulative film layer preferably is inserted between a pair of electrodes.

Materials used for the insulating layer include, for example, aluminum oxide, lithium fluoride, lithium oxide, cesium fluoride, cesium oxide, magnesium oxide, magnesium fluoride, calcium oxide, calcium fluoride, aluminum nitride, titanium oxide, silicon oxide, germanium oxide, silicon nitride, boron nitride, molybdenum oxide, ruthenium oxide, vanadium oxide, and the like.

A mixture or layers of these may be employed, too.

The priority application Number JP2007-112154 upon which this patent application is based is hereby incorporated by reference.

What is claimed is:

1. An organic electroluminescence device, comprising:
an anode;
a cathode; and
an emitting layer interposed between the anode and the cathode, wherein
the emitting layer contains a host, a first dopant, and a second dopant,
a luminous intensity of the first dopant is twelve times as great as a luminous intensity of the second dopant or greater, and
the emitting layer is formed by a coating process.

2. The organic electroluminescence device according to claim 1, wherein
a content of the second dopant is 0.001% by mass to 0.5% by mass.

3. The organic electroluminescence device according to claim 1, wherein an energy gap of the first dopant is greater than an energy gap of the second dopant.

4. The organic electroluminescence device according to claim 1, further comprising an electron transporting layer interposed between the emitting layer and the cathode, wherein
an affinity level of the second dopant is greater than an affinity level of the host by 0.2 eV or more, and
electron mobility of the electron transporting layer is 10⁻⁴ cm²/Vs or greater at an electric intensity of 0.25 mV/cm.

5. The organic electroluminescence device according to claim 4, wherein
the electron transporting layer contains a nitrogen-containing heterocyclic derivative represented by a following formula (1),
HAr-L-Ar¹—Ar² (1)
where HAr is a substituted or unsubstituted nitrogen-containing heterocyclic group having 3 to 40 carbons;
L is a single bond, a substituted or unsubstituted arylene group having 6 to 60 carbons, a substituted or unsubstituted heteroarylene group having 3 to 60 carbons, or a substituted or unsubstituted fluorenylene group;
Ar¹ is a substituted or unsubstituted divalent aromatic hydrocarbon group having 6 to 60 carbons; and
Ar² is a substituted or unsubstituted aryl group having 6 to 60 carbons or a substituted or unsubstituted heteroaryl group having 3 to 60 carbons.
